(19) United States
(12) Patent Application Publication
(10) Pub. No.: US 2026/0075487 A1
(43) Pub. Date: Mar. 12, 2026

(54) METHODS, ARCHITECTURES, APPARATUSES AND SYSTEMS FOR MOBILITY TRIGGERING BASED ON NETWORK PREDICTIONS IN WIRELESS NETWORKS

(71) Applicant: InterDigital Patent Holdings, Inc., Wilmington, DE (US)

(72) Inventors: Filipe Conceicao, London (GB); James Miller, Northport, NY (US); Oumer Teyeb, Montreal (CA); Yugeswar Deenoo Narayanan Thangaraj, Chalfont, PA (US); Ognen Ognenoski, London (GB)

(21) Appl. No.: 19/101,110

(22) PCT Filed: Aug. 7, 2023
(86) PCT No.: PCT/US2023/029625

§ 371 Date: Feb. 4, 2025

Related U.S. Application Data
(60) Provisional application No. 63/395,519, filed on Aug. 5, 2022.
(60) Provisional application No. 63/410,727, filed on Sep. 28, 2022.
(60) Provisional application No. 63/421,903, filed on Nov. 2, 2022.

(51) Int. Cl. H04W 36/08; H04W 36/00; H04W 36/36

(52) U.S. Cl. CPC H04W 36/08; H04W 36/0069; H04W 36/362

(57) ABSTRACT

Procedures, methods, architectures, apparatuses, systems, devices, and computer program products for handover procedures which use network predicted measurements. For example, a wireless transmit/receive unit (WTRU) may receive a handover command. The WTRU may receive a first set of measurements from a network. For example, the first set may be predicted measurements. The network may use artificial intelligence and/or machine learning models to generate the first set. The WTRU may obtain (e.g., measure and/or predict) a second set of measurements. The first and/or second set of measurements may be associated with a (e.g., same) first time interval and/or confidence level. Based on a comparison between the first set and second set, the WTRU may determine (i) to execute a handover, in a second time interval, and/or (ii) send feedback information. For example, the WTRU may determine an ideal time to actually execute the handover.

### CROSS-REFERENCE TO RELATED APPLICATIONS

This application claims the benefit of U.S. Provisional Patent Application Nos. (i) 63/395,519 filed 5 Aug. 2022, and (ii) 63/410,727 filed 28 Sep. 2022, and (iii) 63/421,903 filed 2 Nov. 2022; each of which is incorporated herein by reference.

### TECHNICAL FIELD

The present disclosure is generally directed to the fields of communications, software and encoding, including, for example, to methods, architectures, apparatuses, systems directed to triggering mobility procedures, such as cellular handovers (HOs), based on network predictions, such as predicted signal levels of serving and/or neighbor cells. More specifically, after the reception of a HO command from a network or detection of a triggering condition for a conditional HO, an ideal time to actually execute the HO may be determined.

### BACKGROUND

Cellular HOs may encounter failures due to being performed too late, too early, or to a wrong cell. Solutions would be desirable to address such scenarios where HOs may fail.

### SUMMARY

In a representative embodiment, a wireless transmit/receive unit (WTRU) may receive information indicating a first set of network predicted radio measurements and timestamps. The WTRU may receive configuration information indicating a handover (HO) window for a target cell and a time offset. The WTRU may perform and/or predict a second set of radio measurements based on the timestamps. The WTRU may send, at one or more first times that are no later than the time offset before the HO window, information indicating an evaluation of the first set of network predicted radio measurements and the second set of radio measurements. The one or more first times may be based on the HO window and the time offset. The WTRU may perform, at a second time within the HO window, a HO to the target cell based on the configuration information.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a procedural diagram illustrating an example RRC reconfiguration sequence;

FIG. 3 is a procedural diagram illustrating an example RRC resume sequence;

FIG. 4 is a list illustrating an example of a plurality of events which are associated with measurement report triggering;

FIG. 5 is a timing diagram illustrating an example of measurement report triggering;

FIG. 6 is a procedural diagram illustrating an example cell-level mobility sequence;

FIG. 7 is a system diagram illustrating an overview of what occurs over time to a WTRU in the context of a handover;

FIG. 8 is a block diagram illustrating an example of obtaining network predictions for RSRP;

FIG. 9 is a block diagram illustrating an example of obtaining WTRU predictions for RSRP;

FIG. 10 is a block diagram illustrating an example of obtaining WTRU predictions for UL buffer status;

FIG. 11 is a block diagram illustrating an example of obtaining WTRU predictions for a number of retransmissions;

FIG. 12 is a timing diagram illustrating an example of a network prediction procedure;

FIG. 13 is a timing diagram illustrating examples of fixed and variable RSRP boundaries;

FIG. 14 is a system diagram illustrating an overview of what occurs over time to a WTRU in the context of a handover utilizing predictions;

FIG. 15. is a timing diagram illustrating an example of a handover procedure utilizing predictions;

FIG. 16 is a timing diagram illustrating examples of handover triggers for different handover types and WTRU prediction lengths;

FIG. 17 is a flow diagram illustrating an example of a layer 3 (L3) communication procedure in accordance with certain embodiments;

FIG. 18 is a flow diagram illustrating an example of a layer 3 (L3) communication procedure in accordance with certain embodiments;

FIG. 19 is a procedural diagram illustrating an example feedback and HO procedure for a WTRU;

FIG. 20 is a procedural diagram illustrating an example HO procedure for a WTRU;

FIG. 21 is a procedural diagram illustrating an example feedback procedure for a WTRU;

FIG. 22 is a procedural diagram illustrating an example admission control procedure for a first base station;

FIG. 23 is a procedural diagram illustrating an example HO procedure for a WTRU;

FIG. 24 is a procedural diagram illustrating an example HO procedure for a WTRU; and

FIG. 25 is a procedural diagram illustrating an example feedback procedure for a base station.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

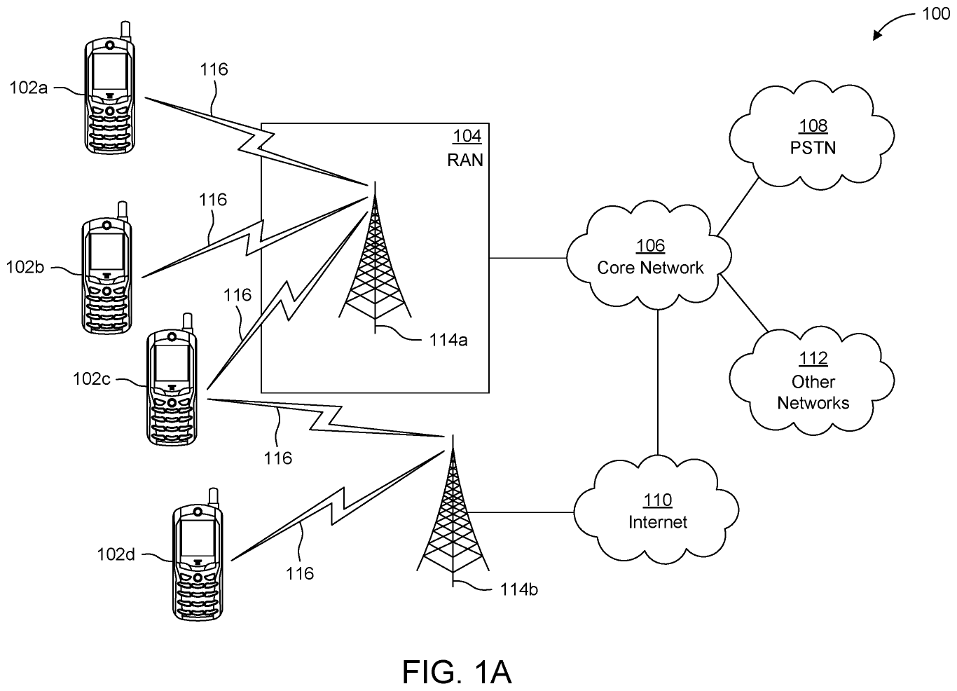

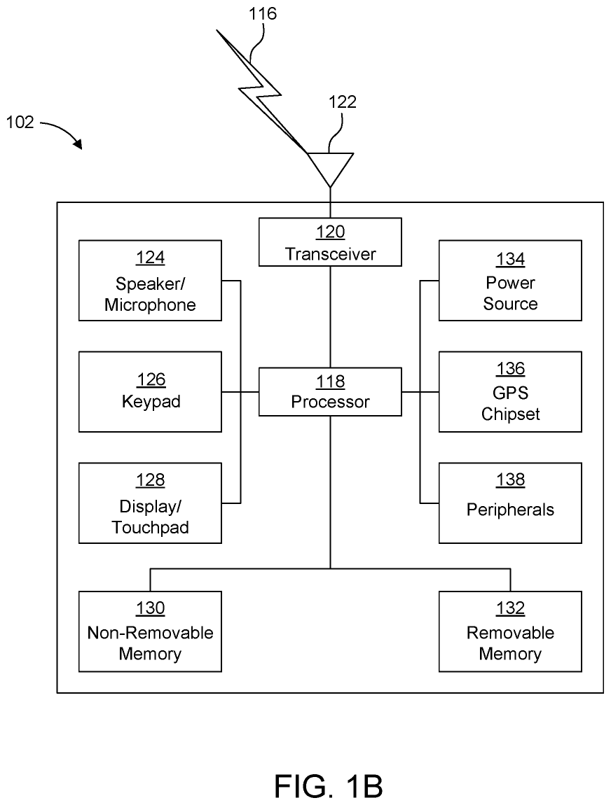

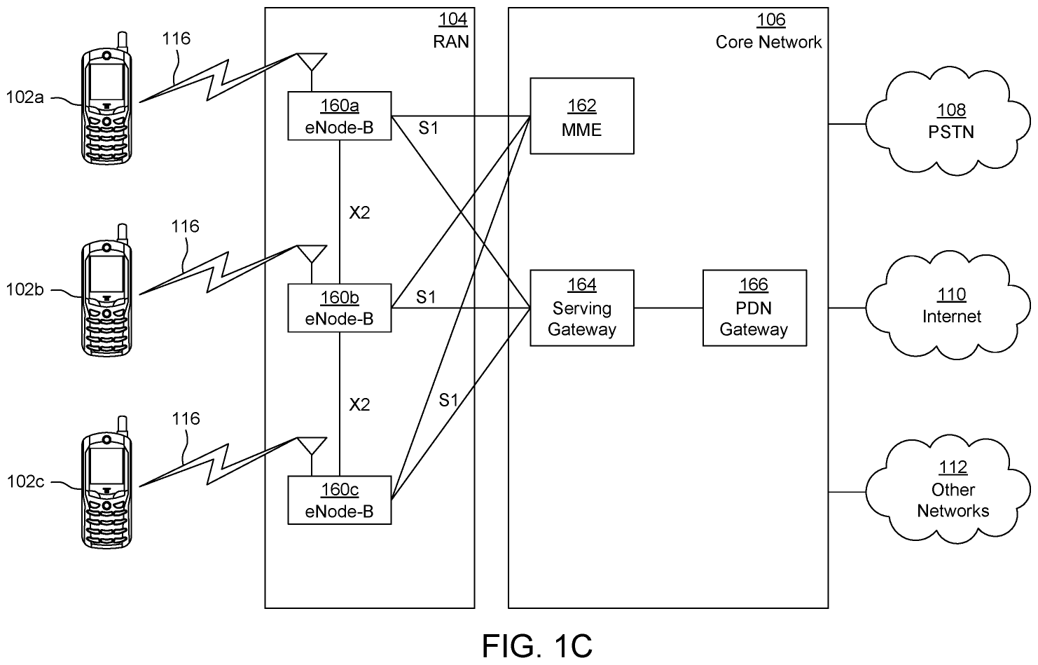

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Inte rim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c ). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

In certain representative embodiments, a WTRU 102 may be configured with any of: (1) a handover (HO) message, (2) (e.g., network) predicted serving cell and/or neighboring cell signal levels, (3) a first time duration/interval (or indication thereof), and/or (4) a second time duration/interval (or indication thereof). For example, the predicted cell signal levels may be based on artificial intelligence (AI) and/or machine learning (ML). On condition that the predicted signal levels (e.g., by the network) satisfy (e.g., within a certain error level, range or margin) (e.g., actual) measurements performed or predicted by the WTRU 102 within (or during) the first time duration, the WTRU 102 may execute a HO within the second time duration.

In certain representative embodiments, a WTRU 102 may send feedback information regarding the predicted serving or/and neighbor signal levels provided by the network. For example, the feedback information may be triggered (e.g., to be sent) on condition there is a mismatch (e.g., outside of a certain error level, range or margin) between the predicted signal levels and the (e.g., actual) measurements performed or predicted by the WTRU 102 (e.g., within the first time duration).

In certain representative embodiments, a network (e.g., RAN) node may perform enhanced admission control by validating the admission of a WTRU (e.g., in the future) based on a prediction of a time that the WTRU 102 will be handed over (e.g., perform the HO).

### Overview

The following acronyms may be used herein:
ACK Acknowledgement
BLER Block Error Rate
BWP Bandwidth Part
CAP Channel Access Priority
CAPC Channel access priority class
CCA Clear Channel Assessment
CCE Control Channel Element
CE Control Element
CG Configured grant or cell group
CHO Conditional Handover
CLI Crosslink Interference
CP Cyclic Prefix
CP-OFDM Conventional OFDM (relying on cyclic prefix)
CQI Channel Quality Indicator
CRC Cyclic Redundancy Check
CSI Channel State Information
CW Contention Window
CWS Contention Window Size
CO Channel Occupancy
DAI Downlink Assignment Index
DAPS Dual Access Protocol Stack
DCI Downlink Control Information
DFI Downlink feedback information
DG Dynamic grant
DL Downlink
DM-RS Demodulation Reference Signal
DRB Data Radio Bearer
eLAA enhanced Licensed Assisted Access
FeLAA Further enhanced Licensed Assisted Access
HARQ Hybrid Automatic Repeat Request
KPI Key Performance Indicator
LAA License Assisted Access
LBT Listen-Before-Talk
LTE Long Term Evolution e.g. from 3GPP LTE R8 and up
NACK Negative ACK
MCS Modulation and Coding Scheme
MIMO Multiple Input Multiple Output
NR New Radio
OFDM Orthogonal Frequency-Division Multiplexing
PHY Physical Layer
PID Process ID
PO Paging Occasion
PRACH Physical Random Access Channel
PSS Primary Synchronization Signal
RA Random Access (or procedure)
RACH Random Access Channel
RAR Random Access Response
RCU Radio access network Central Unit
RF Radio Front end
RLF Radio Link Failure
RLM Radio Link Monitoring
RNTI Radio Network Identifier
RO RACH occasion
RRC Radio Resource Control
RRM Radio Resource Management
RS Reference Signal
RSRP Reference Signal Received Power
RSSI Received Signal Strength Indicator
SDU Service Data Unit
SL Sidelink
SRS Sounding Reference Signal
SS Synchronization Signal
SSB Synchronization Signal Block
SSS Secondary Synchronization Signal
SWG Switching Gap (in a self-contained subframe)
SPS Semi-persistent scheduling
SUL Supplemental Uplink
TB Transport Block
TBS Transport Block Size
TRP Transmission/Reception Point
TSC Time-sensitive communications
TSN Time-sensitive networking
UL Uplink
URLLC Ultra-Reliable and Low Latency Communications
WBWP Wide Bandwidth Part
WLAN Wireless Local Area Networks and related technologies (IEEE 802.xx domain)

HO failure KPIs may (e.g., always) suffer from degradation to a certain degree. For example, HO failures are classified in 3GPP in three categories: too early, too late, and HO to wrong cell. These failures, in many instances, may be the result of a wrong network configuration and/or latency of the signaling required for mobility operations. A wrong configuration may lead to an unnecessary resource reservation at target HO nodes. Mobility decisions are measurement based and Uu latency may create a gap between WTRU radio experience and the corresponding network awareness. As an example, a problem in this context is a too late HO. AI/ML techniques may be employed to solve these problems.

In certain representative embodiments, a network-to-WTRU HO evaluation strategy transfer may be based on AI/ML methods. For example, the network (e.g., a network entity) may predict a HO related configuration and WTRU measurements. The predicted HO strategy (e.g., a HO command and network predicted measurements on which the HO was based on) may be sent to a WTRU 102 along with criteria for evaluation (e.g., duration and/or time information of the predicted measurements). The WTRU 102 may validate the provided predicted measurements within a certain duration or interval (e.g., by comparing the predicted measurements with current and/or actual measurements). On condition the WTRU 102 determines there is a satisfactory match (e.g., deviation or difference, such as mean square error, between the predicted and actual measurements is below a certain level), the WTRU 102 will execute the HO command (e.g., within a certain duration after a validation period). On condition the WTRU 102 determines there is not satisfactory match (e.g., deviation or difference is above a certain level), the WTRU 102 may refrain from executing the HO and may send feedback information to the network. For example, the feedback may be information such as the measurements performed by the WTRU 102 and/or error level between the provided predicted measurements and the measurements performed by the WTRU 102.

### Measurement Configurations

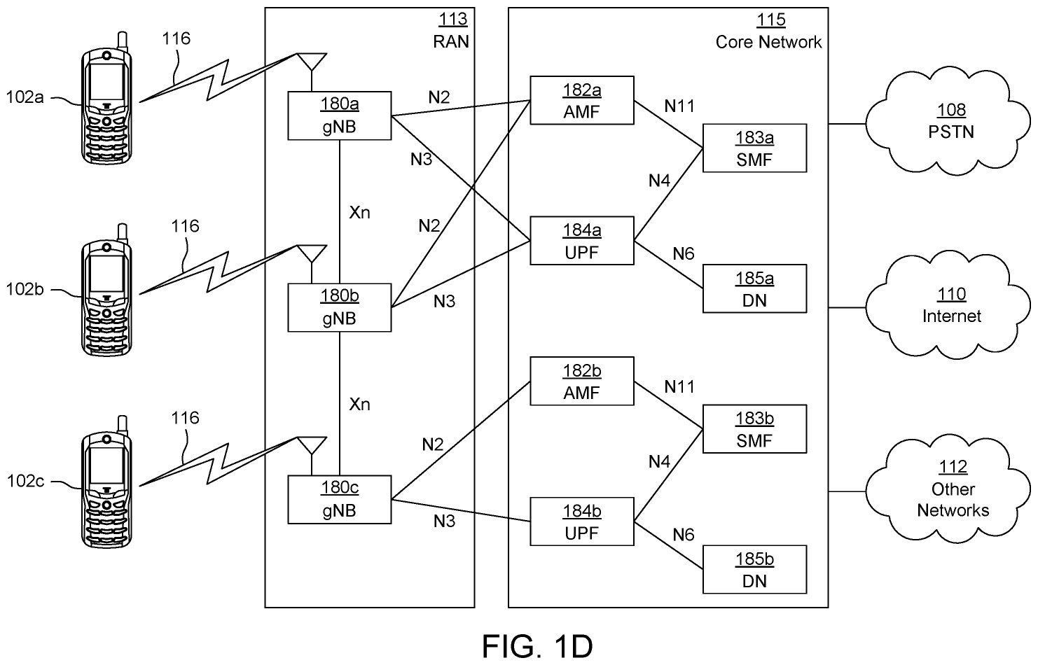

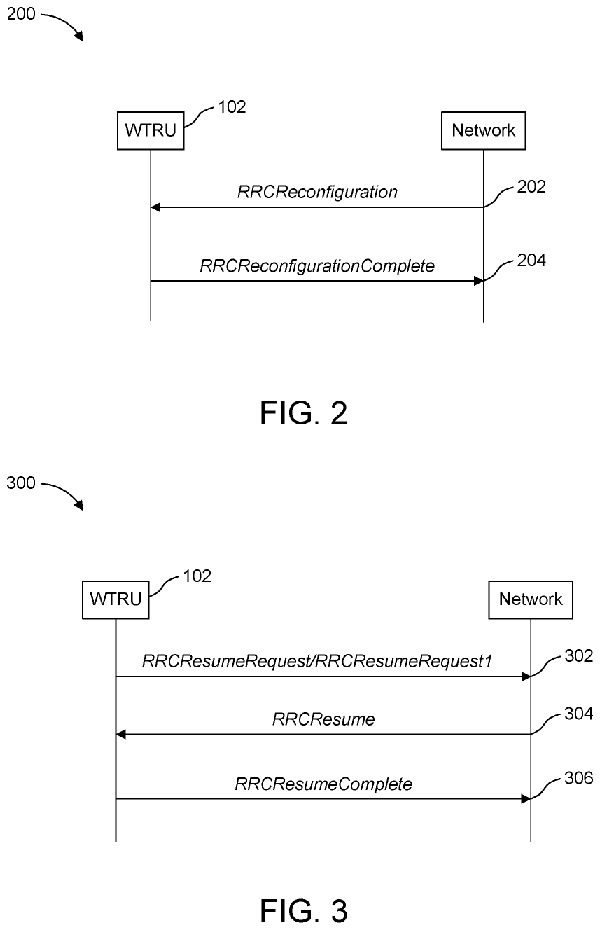

In certain representative embodiments, a WTRU 102 (e.g., in RRC_Connected) may be configured by the network to perform measurements and report the measurements back to the network (e.g., according to a specific configuration). For example, a (e.g., measurement and/or reporting) configuration may be provided and/or indicated by signaling (e.g., using a RRCReconfiguration or RRCResume message). FIG. 2 is a procedural diagram illustrating a RRC reconfiguration sequence 200. The network may send a RRCReconfiguration message to a WTRU 102 at 202. The WTRU 102 may respond with a RRCReconfigurationComplete message at 204. FIG. 3 is a procedural diagram illustrating a RRC resume sequence 300. The WTRU 102 may send a RRCResumeRequest (or RRCResumeRequest1) message to the network at 302. The network may send a RRCResume message to a WTRU 102 at 304. The WTRU 102 may respond with a RRCResumeComplete message at 306.

In certain representative embodiments, a WTRU 102 may perform measurements of RSs, such as any of SSBs, CSI-RSs, SRSs, etc., using a network provided configuration.

For example, the network may configure a WTRU 102 to report any of the following measurement information based on SS/PBCH block(s):
Measurement results per SS/PBCH block;
Measurement results per cell based on SS/PBCH block(s); and/or
SS/PBCH block(s) indexes.

For example, the network may configure a WTRU 102 to report any of the following measurement information based on CSI-RS resources:
Measurement results per CSI-RS resource;
Measurement results per cell based on CSI-RS resource(s); and/or
CSI-RS resource measurement identifiers.

For example, the network may configure a WTRU 102 to perform any of the following types of measurement information (e.g., for NR SL and/or V2X SL):
CBR measurements.

For example, the network may configure a WTRU 102 to report any of the following CLI measurement information based on SRS resources:
Measurement results per SRS resource; and/or
SRS resource(s) indexes.

For example, the network may configure a WTRU 102 to report any of the following CLI measurement information based on CLI-RSSI resources:
Measurement results per CLI-RSSI resource; and/or
CLI-RSSI resource(s) indexes.

### Measurement Reporting Configuration

In certain representative embodiments, a measurement reporting configuration may include any of the following:

Reporting criterion: a (e.g., one or more) criterion that triggers the WTRU 102 to send a measurement report, such as periodic and/or single event description;
RS type: a RS that the WTRU 102 uses for beam and cell measurement results, such as SSB or CSI-RS; and/or
Reporting format: quantities per cell and/or per beam that the WTRU 102 includes in the measurement report (e.g., RSRP) and other associated information, such as the maximum number of cells and the maximum number beams per cell to report.

In certain representative embodiments, WTRU measurement reporting may be configured by the network to be triggered based on any of:

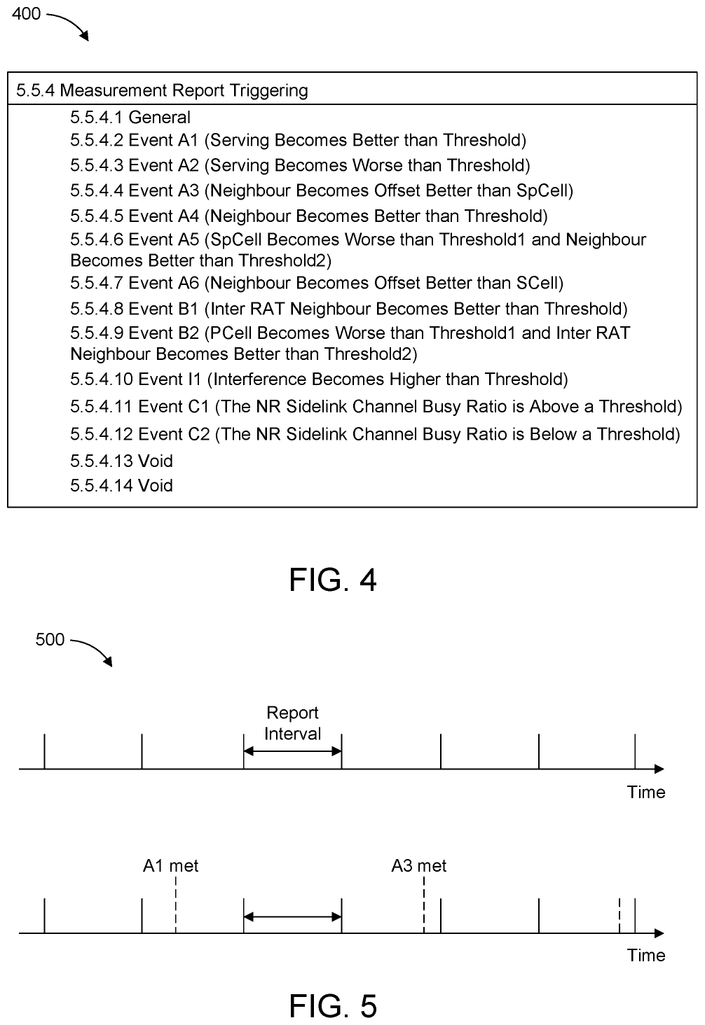

Periodic reporting:
ReportInterval::=ENUMERATED {ms120, ms240, ms480, ms640, ms1024, ms2048, ms5120, ms10240, ms20480, ms40960, min1,min6, min12, min30} Event-triggered:
ReportInterval::=ENUMERATED {ms120, ms240, ms480, ms640, ms1024, ms2048, ms5120, ms10240, ms20480, ms40960, min1,min6, min12, min30} with may be associated with other criteria. FIG. 4 is a list illustrating a plurality of events which are associated with measurement report triggering. Details of the list of report triggering events shown in FIG. 4 may be found in 3GPP TS 36.331, Evolved Universal Terrestrial Radio Access (E-UTRA); Radio Resource Control (RRC); Protocol Specification v17.2.0 (2022-09). For example, any of the events in FIG. 4 may be used as criteria. Those skilled in the art should be familiar with the events listed in FIG. 4.

For example, a measurement report may be triggered based on event criteria being met and/or a timer interval (e.g., a timer value) for a ReportInterval time quantity that has expired (e.g., lapsed). FIG. 5 is a timing diagram illustrating measurement report triggering. As an example, a periodic report may be triggered on condition that a ReportInterval has been determined to have expired and/or lapsed. As another example, an event triggered report may occur on condition that event criterion/criteria have been satisfied (e.g., event A1 condition is satisfied and/or event A3 condition is satisfied).

Measurement reports may be used by the network to determine whether to trigger cell level mobility. The time needed for the network to receive a measurement report and issue a Handover (HO) command (RRC reconfiguration) needs to be taken into account and is herein referred to as air interface latency.

### Mobility

In certain representative embodiments, cell-level mobility may require and/or use (e.g., explicit) RRC signaling for triggering, such as for HO.

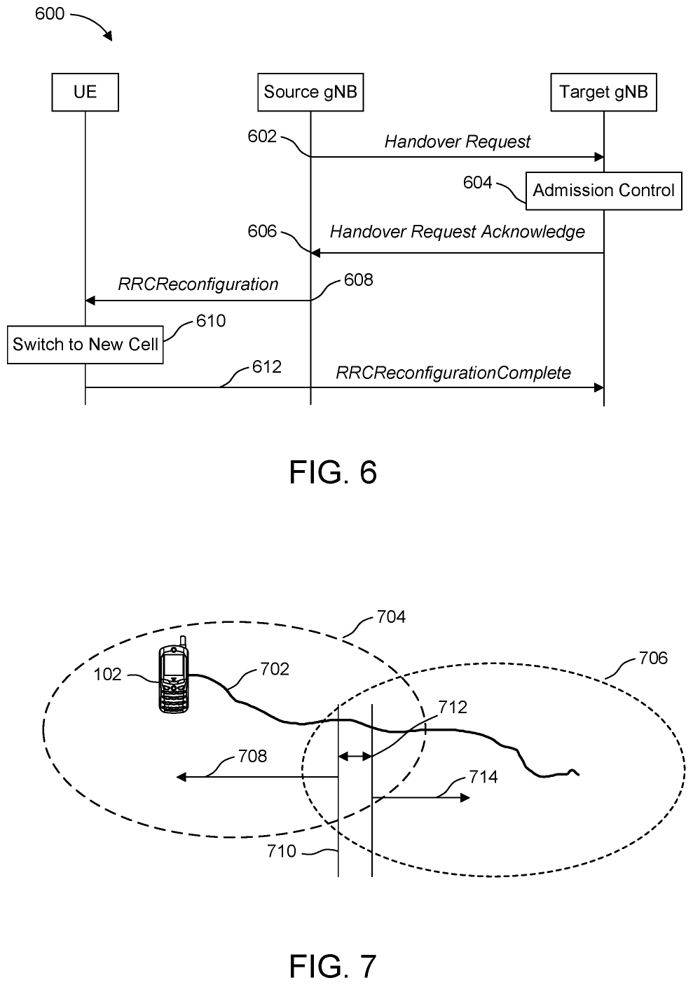

FIG. 6 is a procedural diagram illustrating a cell-level mobility sequence. An inter-gNB HO may include the sequence shown in FIG. 6. At 602 a source gNB (e.g., 180a) may initiate HO and issue a HO request message over a Xn interface to a target gNB (e.g., 180b). At604, the target gNB may perform admission control. At 606, the target gNB may provide a (e.g., new) RRC configuration as part of a HO request acknowledge message at 606. At 608, the source gNB may provide (e.g., indicate) the RRC configuration to the WTRU 102 by sending (e.g., forwarding) a RRCReconfiguration message received in the HO request acknowledge message. For example, the RRCReconfiguration message may include a cell ID and other (e.g., all) information for accessing the target cell (e.g., so that the WTRU can access the target cell without reading system information). In some representative embodiments, information (e.g., required) for contention-based and/or contention-free random access may be included in the RRCReconfiguration message. The access information to the target cell may include beam specific information. At 610, the WTRU 102 may move (e.g., switch) the RRC connection to the target gNB. At 612, the WTRU 102 may reply with a RRCReconfigurationComplete message to the target gNB.

In FIG. 6, the handover preparation stages between the gNBs (e.g., RAN nodes) where 602 and 606 are the source gNB requesting the target gNB to accommodate the WTRU 102, and the target node responds to the source node, confirming it can accommodate the WTRU 102.

In certain representative embodiments, different (e.g., three) types of HO can occur. The first two types of HOs, namely legacy and DAPS HOs, are triggered immediately upon reception of the RRCReconfiguration message at 608 by the WTRU 102. In the case of the third type of HO, namely CHO, the WTRU 102 receives a configuration of a group of cells and associated radio conditions to monitor (e.g., the HO triggering criteria). Once the criterion/criteria are met for a given cell of the group, the WTRU 102 may then trigger HO to the given cell.

In certain representative embodiments, a HO failure may be classified into three categories or types: (1) too late, (2) too early, and (3) wrong cell. In cases where a HO is too late, a WTRU 102 receives a HO command but before the WTRU 102 is able to trigger the HO to the target cell, a RLF occurs in the source cell. In cases where a HO is too early, a WTRU 102 is able to trigger the HO to a target cell, and the HO either fails due to bad radio conditions at the target cell or it succeeds but fails shortly thereafter. In cases where a HO is to a wrong cell, the HO fails at the target cell and there were other and/or better candidate cells in terms of radio conditions. HO failures may occur due to misconfiguration of the WTRU 102 and may include misconfiguration of target cells, HO timing, and/or the triggering criteria used for the evaluation of the radio conditions.

At 608. in FIG. 6, in a WTRU 102 may trigger a HO (e.g., legacy or DAPS HO) after (e.g., immediately upon) reception of the RRCReconfiguration message. On condition that the HO fails and falls in the too late HO failure category, it is evident that the RRC Reconfiguration message may have been sent too late to the WTRU 102.

In the case of regular HO and CHO, while executing the HO, the WTRU releases the connection to the source cell before the link to the target cell is established (e.g., UL and DL transmission is terminated in the source cell before the WTRU starts to communicate with the target cell). This results in an interruption time of about a few tens of milliseconds in the communication between the WTRU and the network.

FIG. 7 is a system diagram illustrating an overview of what occurs over time to a WTRU in the context of a handover. A WTRU 102 may have a trajectory 702 corresponding to the WTRU 102 moving across a first cell 704 and then to a second cell 706.

During a time period 708, the WTRU's serving cell is the first cell 704 and both uplink and downlink transmissions of the WTRU 102 are toward the first cell 704. At a time 702, the WTRU 102 receives an HO instruction from the network or the CHO criteria is met and the WTRU 102 triggers the HO immediately. A time period 712 is a period during which communications between the WTRU 102 and the network are interrupted, which comprises a non-optimal point for the UL switch that does not consider radio, QoS, or UL buffer related status. Finally, during at time period 714, the second cell 706 is the service cell for the WTRU 102 and both its uplink and downlink transmissions are now toward that the second cell 706.

As can be seen in FIG. 5, the WTRU 502 was within the coverage of the first cell 706 for a considerable time even after the triggering and/or execution of the HO. Further, the HO can be triggered responsive to events other than radio conditions (e.g., load balancing, network energy savings, etc.), where the radio conditions with the source cell are still good or even better than with the target cell. As such, it is not always necessary to execute the HO (e.g., CHO) immediately, which may cause unnecessary UL data interruption (e.g., for bearers that have very strict latency requirements).

Thus, when a WTRU 102 is provided with a HO command from the network or CHO conditions are fulfilled, it would be beneficial to determine and then utilize the optimal time (e.g., moment) to execute the HO, such as when the HO does not have to be executed immediately due to radio conditions.

### Statistical Aspects of Machine Learning

### Estimation Accuracy Over Time

Machine learning (ML) models are, amongst other functions, for example, may be able to forecast or predict future values of a given quantity (e.g., parameter). A prediction may be associated with a certain timestamp value (e.g., time instance). For example, a timestamp may be generalized as a future time step (e.g., yet to occur). With each predicted value, there may (e.g., always) be an estimation of the error or deviation that the predicted value may have. In certain representative embodiments, an estimated error may be calculated (e.g., recursively). For example, the longer the time horizon associated with the predicted value, the worse (e.g., greater) the estimation may be expected to be. As an example, a ML model outputting a prediction (e.g., sample) at a time step t+4 may in principle be expected to have both the estimated value of that prediction (e.g., sample) and an estimation of the error associated therewith which are more accurate than for a pair of prediction and error at a further future time step (e.g., t+7).

### Prediction Intervals

With predictive inferences, a prediction interval may be an estimate of an interval in which a future observation will fall, with a certain probability, given what has already been observed (e.g., via measurement, sampling or the like). In certain representative embodiments, a ML model may output an interval associated with a prediction, which may be based on a probability P (e.g., associated with the prediction and/or interval). For example, assuming a probability given by P=0.95 or 95%, then a model may output a window of values where it is estimated that a predicted value for any future time step will fall within the given window, with a 95% probability. In general, different values for a confidence probability may generate different prediction windows (e.g., intervals).

With HOs to a wrong cell and too early HOs, the HO failure may relate to the inability of the network to properly grasp what is happening with the radio conditions experienced by the WTRU 102. The network may send RRC Reconfiguration messages to WTRUs based on measurements received by the WTRUs in measurement reports. These may follow a periodic or event triggered pattern. The period may be configurable via parameters and if the period is too long, there may be a gap between measurements reports where the network does not know what signal conditions the WTRU 102 has measured. If the period is too short, then the WTRU 102 may keep triggering measurement reports, increasing signaling overhead. For event-based measurement reporting, reporting may be based on a limited number of events and if the thresholds are not properly configured, the WTRU may be too late to trigger sending measurements.

Additionally, and in particular for the case of CHO, there may also exist a resource reservation problem. When a WRU 102 is configured for CHO, the source node may request a target node to accommodate the WTRU 102. If a result of the admission control of the target node is to accommodate the WTRU 102, then resources may be reserved (e.g., immediately) as there may not be a mechanism to optimize a resource reservation time to match the HO by the WTRU 102.

Leveraging AI/ML techniques, models may be trained to accurately predict measurements and consequently, predict and improve network HO configurations. Improvements to allow a WTRU 102 to receive predicted measurements from the network may be desirable to enable the WTRU 102 to be able to evaluate the radio conditions it experiences against the network predicted radio conditions. Doing so may close the timing gap existing between the WTRU measuring, reporting, a HO decision at the network, and then providing a HO command to the WTRU 102.

### WTRU and Network Predictions

Described below are examples of the kinds of prediction capabilities based on AI/ML techniques that can be performed at a WTRU 102 or network.

In a simple mobility scenario, a WTRU 102 in mobility may measure a current serving cell's RSRP and report it to the network. If the WTRU 102 is moving to an area approaching the serving cell's edge, it may measure and record that RSRP values are decreasing. These values may be communicated to the network via measurement reports so that the network may make a decision as to whether HO to a different cell is necessary.

For purposes of the following discussion, both a WTRU 102 and/or the network may be assumed to have a pre-trained AI/ML model that is able to produce predictions of air-interface measurements (e.g., RSRP, RSRQ, SINR, etc.) of serving and/or neighbor cells (e.g., any detectable cell), WTRU UL buffer levels, and/or QoS related metrics.

In certain representative embodiments, radio conditions as experienced at a WTRU 102 may be based on real measurements the WTRU 102 performs over time. In an example mobility scenario, a WTRU 102 (e.g., in mobility) may determine a current serving cell's RSRP and report the determined RSRP to the network. If the WTRU 102 is moving to an area approaching the serving cell's edge, it may determine that RSRP values are decreasing (e.g., for the serving cell). These RSRP values may be communicated to the network via measurement reports in order for the network to make a decision (e.g., regarding whether to issue a HO command).

In certain representative embodiments, the network may be assumed to have a pre-trained AI/ML model that is available to produce predictions of air-interface measurements (e.g., RSRP, RSRQ, SINR, etc.) of serving and/or neighbor cells (or any other cell). For example, the predicted measurements may be used to anticipate the radio conditions a WTRU 102 may experience, instead of or in advance of the WTRU 102 reporting actual measurements.

For example, the predictions of radio conditions are a tool to anticipate the radio conditions a WTRU 102 will experience, rather than waiting for the WTRU 102 to report the radio conditions.

For example, the predictions of UL buffer levels are a tool to anticipate the UL service requirements for a WTRU 102. It is considered herein that the UL buffer levels can be predicted in their entirety (e.g., for a WTRU 102), and/or for one or more PDU sessions (e.g., established between a WTRU 102 and the UPF 184 in the CN 115), and/or for one or more DRBs (e.g., one PDU session may have one or more DRBs) and/or for one or more QoS Flow Identifiers (QFIs) (e.g., each DRB may have one or more QFIs).

For example, the QoS related predictions are a tool to anticipate certain QoS related metrics.

In order to produce more meaningful predictions in this context, in certain embodiments, it makes sense to have the WTRU 102 and/or the network make the predictions in a time series manner. This means that, from the moment the predictions are triggered, an AI/ML model will produce several prediction outputs over a future time span, with a certain granularity and/or time step.

In certain representative embodiments, the network may predict (e.g., using the trained AI/ML model) radio interface measurements (e.g., RSRP) at a WTRU 102 in a time-series manner. For example, from a timer where the network predictions are triggered, the WTRU 102 may produce several prediction outputs over a (e.g., future) time span, such as with a certain granularity or time step.

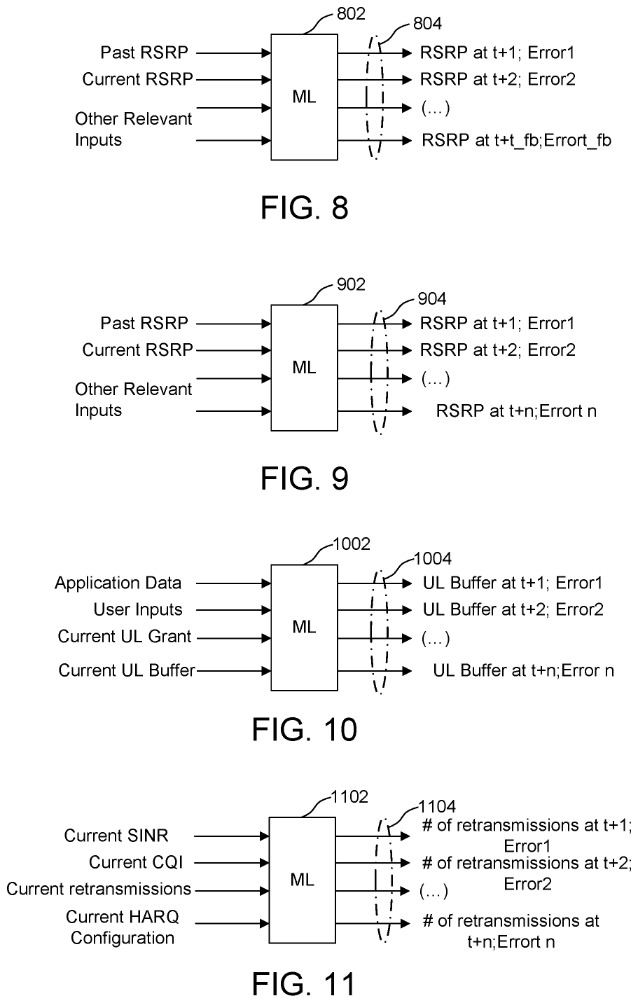

FIG. 8 is a block diagram illustrating an example of obtaining network predictions. As shown in FIG. 8, a network entity (e.g., a gNB or the like) may be provided with a ML model (and/or AI model) 802 which is trained. In certain representative embodiments, the ML model 802 may use, as inputs, a past measurement(s), a current measurement(s), and/or other parameters or measurements. The measurements may include RSRP, as in FIG. 8, and/or other measurement quantities as described herein (e.g., RSRQ, SINR, etc.). For example, the RSRP measurements may be actual measurements which are reported by a WTRU 102 for a current time ‘t’. The ML model 802, using the inputs, may generate one or more predicted (e.g., RSRP) measurements in time-series as an output 804. For example, where the current time is ‘t’, the one or more predicted measurements may be for a time interval of ‘t+1’, ‘t+2’ to ‘t+t_fb’, such as where 1 is a unit value of time (e.g., based on milliseconds or transmission time intervals). As another example, the predicted measurements may be associated with (e.g., paired with) error values as in FIG. 8.

In certain representative embodiments, the network may obtain the predictions for one point in time only (e.g., ‘t+1’) or for (e.g., extended over) several time steps (e.g., ‘t+1’ to ‘ttt_fb’). In some scenarios, prediction of a time series sequence of output values may be beneficial as compared to single value predictions as it may be difficult to match the prediction with a network configured event when using a single prediction point.

In certain representative embodiments, a WTRU 102 may be configured to predict future measurements based on current and/or historical measurements. For example, the WTRU 102 may be configured with a trained AI/ML model that is able to produce predictions for radio interface radio signal levels. In an example, the AI/ML model at the WTRU 102 may be implementation based. In another example, the WTRU 102 may obtain the AI/ML model from the network.

FIG. 9 is a block diagram illustrating an example of obtaining WTRU predictions for RSRP. FIG. 10 is a block diagram illustrating an example of obtaining WTRU predictions for UL buffer status. FIG. 11 is a block diagram illustrating an example of obtaining WTRU predictions for a number of retransmissions.

At the WTRU 102, the AI/ML model may be configured to take as inputs current and/or historical measurements, such as RSRP, as shown in FIGS. 8 and 9. Other current and/or historical measurements may be used as inputs as shown in FIGS. 10 and 11.

For example, FIG. 9 shows a machine learning model 902 for producing outputs 904 predicting RSRP at various times in the future (e.g., times t+1, t+2, . . . , t+n,), each including an error of the prediction (e.g., error1, error2, . . . , error n) and/or estimated accuracy of the prediction.

For example, FIG. 10 shows a machine learning model 1002 for producing outputs 1004 predicting UL buffer status at various times in the future (e.g., times t+1, t+2, . . . , t+n,) each including an error of the prediction (e.g., error1, error2, . . . , error n) and/or estimated accuracy of the prediction.

For example, FIG. 11 shows a machine learning model 1102 for producing outputs 11 predicting a number (e.g., #) of retransmissions at various times in the future (e.g., times t+1, t+2, . . . , t+n,) each including an error of the prediction (e.g., error1, error2, . . . , error n) and/or estimated accuracy of the prediction.

In some embodiments, the predictions may also be generated for one point in time only.

In many scenarios, predictions with time series outputs may be beneficial when compared to single value predictions as it may be difficult to match the prediction with (e.g., a network configured event with) only a single prediction point. For the case of UL buffers, it may be relevant to assess UL buffer values over a time span for certain decision processes detailed in subsequent sections. The same may be true for QoS related aspects.

These are however practical issues that are beyond the scope of this disclosure. The triggers for predictions are also out of the scope of this disclosure. Nevertheless, a few exemplary implementations are mentioned below for these two aspects (e.g., (1) whether the model resides at the WTRU or in the network and (2) whether a single or a time series of predictions is/are made).

In certain embodiments, a WTRU 102 may be configured to predict future measurements based on current and/or historical measurements. For example, the WTRU 102 may be configured with a trained AI/ML model that is able to produce predictions. The AI/ML model at the WTRU 102 may be implementation based. In another embodiment, the WTRU 102 may obtain the AI/ML model from the network. In certain embodiments, the AI/ML model may be configured to take as an input current and/or historical input values. In certain embodiments, the AI/ML model may be configured to take additional inputs, such as WTRU location information, WTRU mobility, etc. In certain embodiments, the AI/ML model may be configured to produce single value predictions, such as an output value at a single future time instant, t. In certain embodiments, the AI/ML model may be configured to predict a series of predicted values corresponding to multiple future time instances, t+1, t+2, and so on up to t+n.

In certain representative embodiments, the AI/ML model may be configured to take additional inputs (e.g., to supplement the signal measurements), such as WTRU location information, WTRU mobility information, etc. As an example, the AI/ML model may be configured to produce single value predictions (e.g., RSRP) at a future time instant ‘t+1’. In another example, the AI/ML model may be configured to predict a series of (e.g., RSRP) values corresponding to future time instances ‘t+1’, ‘t+2’ and so on up to ‘t+t_fb’, where t_fb is a time at which WTRU reporting is to be fedback to the network.

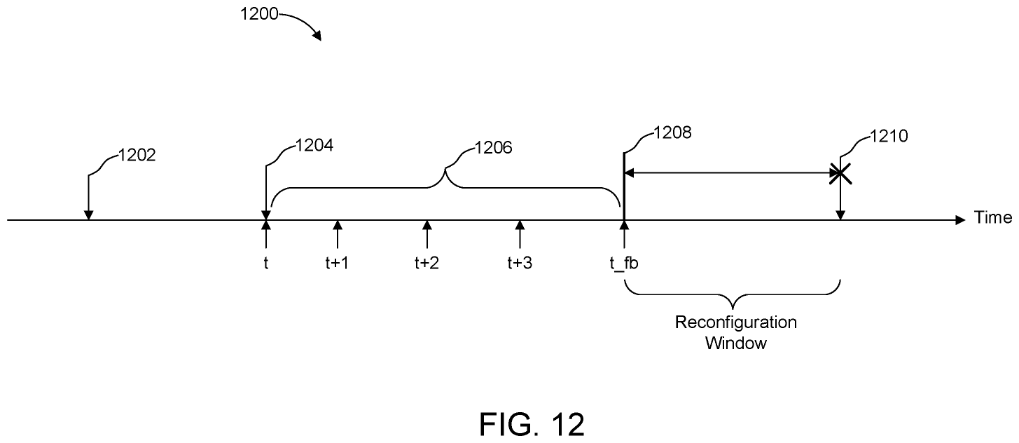

FIG. 12 is a timing diagram 1200 illustrating an example of a network prediction procedure. In certain representative embodiments, a network may predict a HO strategy (e.g., procedure) for a (e.g., particular) WTRU 102 at 1202. For example, the predicted HO strategy may include any of a HO type (e.g., DAPS HO, legacy HO, CHO), any target cell or cells (e.g., in the case of CHO), and/or one or more radio interface quantities, such as RSRP as an example. In some representative embodiments, the predictions may be output in different forms (e.g., for a plurality of time steps of a given interval). For the example, the network may predict a measurement quantity (e.g., a radio interface quantity, such as RSRP) as any of: (1) a single value per time step (e.g., for all time steps), (2) a single value per time step (e.g., for a subset of time steps), (3) a single value per time step (e.g., for a single time step), (4) a range of values per time step (e.g., for all time steps), (5) a range of values per time step (e.g., for a subset of time steps), (6) a range of values per time step (e.g., for a single time step), or (7)a combination thereof. For example, a range of values may be predicted as @t+1−[RSRP1−, RSRP1+], @t+2−[RSRP2−,RSRP2+], . . . , @t+t_fb−,[RSRPt_fb−, RSRPt_fb+], where subscripts − and + indicate to add or subtract a value to a center reference value to create a window. For example, the predicted measurement quantities may be linked or associated with any of a particular cell and/or a group of cells (e.g., generated for different cells where a set/subset of predicted RSRP values are associated with a particular cell). As shown in FIG. 12, a last time step for predictions is indicated as t_fb.

In certain representative embodiments, a network may send (e.g., configure, indicate or otherwise provide) a (e.g., pre-emptive) HO command to a WTRU 102 at 1204 (e.g., time ‘t’). For example, the HO command may be sent as or in the message to the WTRU 102 at 608 in FIG. 6, or via any other message. The WTRU 102 may not immediately trigger a HO as in conventional legacy and DAPS HO cases. In some representative embodiments, the HO command may include, indicate (e.g., implicitly or explicitly), or be associated with, any of: (1) one or more predicted measurement quantities (e.g., as predicted at 1202 in FIG. 12), (2) a time value which may serve as a last time step (e.g., t_fb), (3) a (e.g., configured) window for the WTRU 102 to determine a HO decision, (4) a configuration for the WTRU 102 to evaluate and provide feedback on the received network predictions (e.g., using actual measurements or WTRU-generated predicted values), and/or (5) one or more conditions for the WTRU 102 to trigger the HO (e.g., within the window). For example, the window may be indicated as any of: (1) a range, (2) a difference (e.g., delta) to a time value (e.g., t_fb), (3) a geographic location or area, (4) a distance or range to a current location (e.g., when a configuration is received), (5) a distance or range to a location where the WTRU 102 will be at a time value (e.g., t_fb), and/or (6) distance or range to a location where the WTRU 102 will be at another time.

In certain representative embodiments, a WTRU 102 may be configured with or determine a window (e.g., evaluation and feedback time interval) at 1206 in FIG. 12. For example, the WTRU 102 may confirm (e.g., determine) whether the WTRU 102 experiences (e.g., measures and/or predicts) the network predicted (e.g., radio interface) conditions. As an example, on condition that the WTRU 102 determines that the HO decision is valid (e.g., the network predicted conditions are satisfied), the WTRU 102 may execute a HO (e.g., the HO command). For example, on condition that the WTRU 102 determines that the HO decision is not valid (e.g., the network predicted conditions are not satisfied), the WTRU 102 may not execute a HO (e.g., the HO command). In some representative embodiments, on condition that the WTRU 102 determines that the HO decision is not valid, the WTRU 102 may provide (e.g., trigger) feedback to the network. As an example, the network may configure the WTRU 102 not to execute the HO later on based on the feedback information.

In certain representative embodiments, the network may make mobility decisions based on measurements received from multiple WTRUs. Considering the latency of the air interface, RRC signaling for measurement reporting from a WTRU 102 to the network and any resulting network triggered RRCReconfiguration decision, there may be a minimum time required for transmission of these two messages as well as additional computational time, even if minimal, for evaluation and decision making. As an example, the time ‘t_fb’ at 1208 in FIG. 12 may serve as a time margin that the network needs to receive and assess measurements, decide on a mobility strategy, and/or configure the WTRU 102 for HO. For example, the network may select a value used for this parameter (e.g., carefully) such that the time margin is similar to the latency for signaling the two messages over the air interface. For example, after the time t_fb, the WTRU HO decision may be irreversible (e.g., because there may not be enough time for another Reconfiguration or HO command to be signaled to the WTRU 102).

In certain representative embodiments, a WTRU 102 may be configured, provided, or otherwise indicated with a reconfiguration window as shown between 1208 and 1210 in FIG. 12. The reconfiguration window may serve as a limit for the WTRU 102 to trigger the HO. Between1208 and 12010, the WTRU 102 may trigger the HO at any time (e.g., once the HO condition is met or a time value thereafter, the HO trigger is triggered). Several options may be considered as the when the WTRU 102 determines when exactly to trigger the HO. For example, the WTRU 102 may have some data in a buffer to be sent that may (e.g., ideally or preferentially) be sent before the HO to avoid the HO interrupting the transmission of that data. Those skilled in the art should understand that the WTRU 102 may take into consideration other situations which may affect when the WTRU 102 determines to trigger the HO.

### WTRU Evaluation

In certain representative embodiments, a WTRU 102 may receive (e.g., from a network) a configuration to evaluate and/or feedback information relating to the network predictions. For example, the evaluation of the network predictions may use actual measurements and/or WTRU-generated predictions. By evaluating the network predictions, the WTRU 102 may determine whether what the network predicted will happen in terms of radio conditions (e.g., quantities such as RSRP) is or has actually happened, such as the predicted network conditions being within an acceptable range to the measurements obtained by the WTRU 102 at the radio interface.

For example, a WTRU 102 may perform evaluation using real measurements which may be compared against the received network predictions. As an example, to evaluate a predicted value or range for RSRP associated with a time step ‘t+3’, the WTRU 102 may use an actual measurement obtained by the WTRU 102 (e.g., at ‘t+3’).

For example, a WTRU 102 may perform evaluation using WTRU-generated predictions which may be compared against the received network predictions. As an example, to evaluate a predicted value or range for RSRP associated with a time step ‘t+3’, the WTRU 102 may use predicted measurement obtained by the WTRU 102 (e.g., in advance of ‘t+3’).

For example, a WTRU 102 may perform evaluation using a combination of real measurements and WTRU-generated predictions which may be combined and compared against the received network predictions.

In certain representative embodiments, a WTRU 102 may determine to trigger predictions without network configuration, or may trigger predictions based upon a received network configuration.

For example, a network may provide a configuration which includes (e.g., indicates) options for the WTRU 102 to trigger predictions (e.g., as described herein) that include any of: (1) immediately upon reception of a RRCReconfiguration (e.g., at 608 in FIG. 6 and/or at 1204 in FIG. 12), (2) a specific timestamp to trigger the predictions, (3) a time value to trigger the predictions (e.g., counting milliseconds, symbols, slots, subframes, and/or other time intervals) from a time when the configuration has been received, (4) a specific geographic location to trigger the predictions, and/or (5) a specific geographic area to trigger the predictions (e.g., trigger upon entering an area).

WTRU Feedback In certain representative embodiments, a WTRU 102 may provide (e.g., report or indicate) feedback (e.g., measurement information and/or evaluation information) to the network. The feedback may be based on the evaluation results and/or the predicted measurement values that the WTRU 102 received from the network for comparison purposes.

In certain representative embodiments, a WTRU 102 may use one or more time related triggers for feedback. For example, a WTRU 102 may be configured to trigger feedback to the network (e.g., at every time step until or up to t_fb). For example, a WTRU 102 may be configured to trigger feedback to the network at a particular time (e.g., t_fb). For example, a WTRU 102 may be configured to trigger feedback in a subset of the time steps (e.g., in the [t;t_fb] window).

In certain representative embodiments, a WTRU 102 may use one or more real (e.g., non-predicted) measurement-based triggers. For example, a WTRU 102 may be configured to trigger feedback to the network on condition that a mismatch (e.g., outside of a threshold value or range) is determined (e.g., detected) between one or more received measurement predictions and one or more real measurements, such as for one cell or for a group of cells. For example, a WTRU 102 may be configured to trigger feedback to the network on condition that a mismatch (e.g., outside of a threshold value or range) is determined (e.g., detected) between a received prediction measurements in a prediction window and one or more real measurements, such as for one cell or for a group of cells. For example, a WTRU 102 may be configured to trigger feedback to the network on condition that a rate of change between (e.g., consecutive and/or non-consecutive) time steps of real measurements is above or under a threshold value (or range), such as for one cell or a group of cells.

For example, a WTRU 102 may be configured to trigger feedback to the network using a (e.g., any) measurement evaluation combination for different cells, and considering any of the above-mentioned examples. As an example of using RSRP, feedback may be triggered by the WTRU 102 on condition that (i) a RSRP for a first cell has a change rate for consecutive time steps which is above a (e.g., first) threshold and (ii) a RSRP for second cell has a change rate which is under a (e.g., second) threshold for at least x number of time steps. Other examples may use other measurement quantities than RSRP and/or may use RSRP in combination with other measurement quantities.

In certain representative embodiments, a WTRU 102 may use one or more WTRU-predicted measurement-based triggers. For example, the foregoing trigger examples using real measurements made by a WTRU 102 may instead, or in combination, use WTRU-predicted measurements to trigger feedback. As another example, a WTRU 102 may be configured to trigger feedback to the network based on an estimated error of one or more network predictions being higher than a certain threshold (e.g., regardless of a RSRP comparison between network measurement and WTRU measurement of RSRP). As another example, a WTRU 102 may be configured to not trigger feedback to the network based on an estimated error of one or more network predictions being lower than a certain threshold (e.g., regardless of a RSRP comparison between network measurement and WTRU measurement of RSRP). As another example, a WTRU 102 may be configured to trigger feedback to the network based on an estimated error of one or more WTRU predictions being lower than a certain threshold (e.g., regardless of a RSRP comparison between network measurement and WTRU measurement of RSRP). As another example, a WTRU 102 may be configured to trigger feedback to the network based on an estimated error of one or more WTRU predictions being lower than an estimated error predicted by the network (e.g., regardless of a RSRP comparison between network measurement and WTRU measurement of RSRP). As another example, a WTRU 102 may be configured to trigger feedback to the network based on an average estimated error predicted by the WTRU being lower than an average estimated error predicted by the network (e.g., regardless of a RSRP comparison between network measurement and WTRU measurement of RSRP). As another example, a WTRU 102 may be configured to trigger feedback to the network based on an estimated error of one or more WTRU predictions being lower than an estimated error predicted by the network (e.g., regardless of a RSRP comparison between network measurement and WTRU measurement of RSRP). For example, the WTRU predictions and/or the network predictions may be associated with any of: (1) all time steps of the WTRU evaluation and/or feedback window, (2) a (consecutive and/or non-consecutive) subset of time steps of the WTRU evaluation and/or feedback window, and/or (3) individual time steps of the WTRU evaluation and/or feedback window.

Reporting Signaling In certain representative embodiments, a WTRU 102 may deliver (e.g., send) feedback to the network every time feedback is triggered, may accumulate feedback values and deliver corresponding feedback information (e.g., all at once) at a certain point in time, and/or gradually deliver corresponding feedback information during the evaluation window (e.g., periodically). For example, any feedback triggered from the WTRU 102 to the network might mean that a HO is not ideal (e.g., for the current radio interface conditions). For example, the network may configure the WTRU 102 to decide not to trigger the HO after the time ‘t_fb’ on condition that any of the feedback options have been triggered. For example, the network may configure the WTRU 102 with any legacy HO procedure during the evaluation window on condition that any of the feedback options have been triggered. For example, the network may re-configure the WTRU 102 with more recent predictions, such as in another pre-emptive HO command.

Content of WTRU to Network Feedback Using Predictions In certain representative embodiments, a WTRU 102 may deliver (e.g., send) feedback to the network which may (e.g., shall) identify any of: (1) the corresponding cell (or cells), (2) one or more measurements (e.g., actual or predicted), such as starting and/or ending RSRP values and/or minimum and/or maximum RSRP values, (3) one or more time steps of the measurements, such as a single time value and/or a delta to a time value which may indicate a range window associated with the measurements.

Prediction Intervals In certain representative embodiments, prediction intervals may be incorporated. As described herein, an AI/ML model may be implementation and/or vendor specific, or it may be fetched by a WTRU 102 from the network, or the network may deliver the model to the WTRU 102. The prediction interval and time span of predictions related capability exchanges may be relevant, such as for implementation and/or vendor specific ML models. For example, the same trained model may not be suitable to generate predictions for a same WTRU 102 under different circumstances.

To address prediction intervals, additional information may be incorporated into the WTRU configuration, evaluation and feedback to the NW aspects described herein.

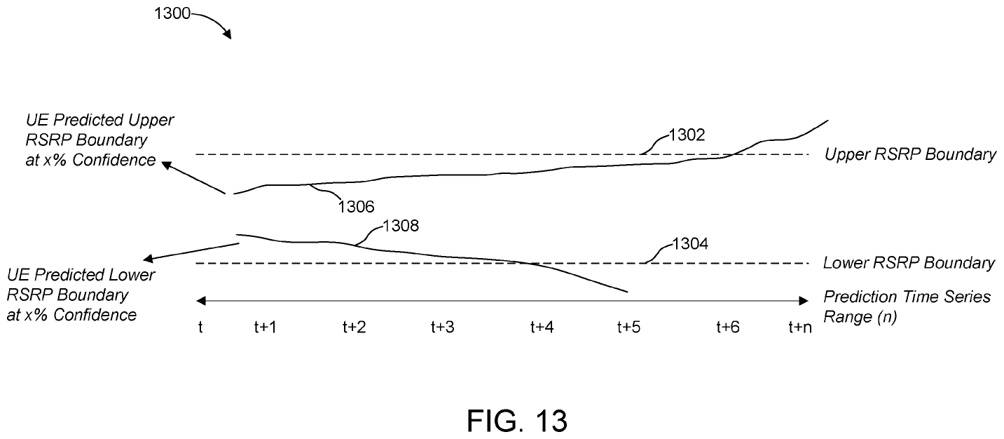

FIG. 13 is a timing diagram 1300 illustrating examples of fixed and variable RSRP boundaries. In other examples, boundaries may correspond to other radio interface quantities and/or measurements. For example, a WTRU 102 may be configured, indicated, and/or determine any of a fixed upper boundary 1302, a fixed lower boundary 1304, a predicted (e.g., variable) upper boundary 1306, and/or a predicted (e.g., variable) lower boundary 1308. As shown in FIG. 13, a WTRU 102 may predict an upper boundary (e.g., threshold) 1306, such as for RSRP, at a respective confidence value (e.g., x %). As shown in FIG. 13, a WTRU 102 may predict a lower boundary (e.g., threshold) 1308, such as for RSRP, at a respective confidence value (e.g., x %). For example, different boundaries and/or thresholds may be associated with different confidence levels and/or intervals.

In the example shown in FIG. 13, prediction boundaries (e.g., confidence intervals) may remain fixed over time (e.g., semi-static) or they may vary (e.g., dynamic, such as predicted by a WTRU 102). Each of the upper and lower boundaries may change differently (e.g., separate or converge over time). In FIG. 13, the time scale is generic and represented over a several samples (e.g., time slots) from t to t+n.

In certain representative embodiments, RSRP evaluation, such as when performing or determining to perform a HO, may account for any of a RSRP associated with a serving cell dropping under a (e.g., first) threshold value and/or a RSRP of a neighbor cell becoming higher than a (e.g., second) threshold value.

As an example, in FIG. 12, the network may generate (e.g., predict) a range of measurement quantity (e.g., a radio interface quantity, such as RSRP) values. The values may be output in different forms (e.g., for a plurality of time steps of a given interval). For the example, the network may predict a measurement quantity as any of: a range of values for each time step (e.g., for all time steps), a range of values for a portion of time steps (e.g., for a subset of time steps), and/or a range of values for certain time steps (e.g., for a single time step). In certain representative embodiments, the generated values may be associated with a confidence value (or range). For example, the network may configure, indicate or otherwise signal to the WTRU 102 the predicted measurement information as well as a confidence value (e.g., as a decimal value or percentage) corresponding to the predictions. As an example, a confidence value may apply to any (e.g., all) predicted ranges for any (e.g., all) time steps. In some embodiments, a confidence value and/or range may change over time.

As another example, a WTRU 102 may may receive (e.g., from a network) a configuration to evaluate and/or feedback information relating to the network predictions. For example, the evaluation of the network predictions may use actual measurements and/or WTRU-generated predictions. A WTRU 102 may also be configured with various triggers for reporting real measurement and/or predicted measurement feedback, and which may include any of the following triggers.

In certain representative embodiments, a WTRU 102 may be configured, indicated and/or signalled to use real measurement-based triggers, such as for reporting information to the network. For example, a WTRU 102 may trigger feedback to the network on condition that a mismatch is detected and/or determined between a received prediction upper boundary of a window and one or more real measurements, such as for one cell and/or a group of cells.

For example, a WTRU 102 may trigger feedback to the network on condition that a mismatch is detected and/or determined between a received prediction lower boundary of a window and one or more real measurements, such as for one cell and/or for a group of cells.

In certain embodiments, multiple triggers can be configured and/or applied using different combinations for different time steps. For example, a WTRU 102 may trigger feedback for a mismatch detected with the upper boundary for a first timestep (e.g., t+1), and/or trigger feedback for a mismatch detected with the lower boundary for a second timestep (e.g., t+2), and/or trigger feedback for any mismatch detected for a third timestep (e.g., t+3).

In certain representative embodiments, a WTRU 102 may be configured, indicated and/or signalled to use WTRU-predicted measurement based triggers, such as for reporting information to the network. For example, a WTRU 102 may, for a given timestep, trigger feedback based on a WTRU-predicted value being less than (or greater than) an offset when compared to a network predicted value (e.g., for a same confidence percentage).

For example, a WTRU 102 may, for a given timestep, trigger feedback based on a WTRU-predicted value being less than (or greater than) an offset when compared to a network predicted value (e.g., for a same confidence percentage) for (e.g., only) an upper boundary.

For example, a WTRU 102 may, for a given timestep, trigger feedback based on a WTRU-predicted value being less than (or greater than) an offset when compared to a network predicted value (e.g., for a same confidence percentage) for (e.g., only) a lower boundary.

For example, a WTRU 102 may, for a given timestep, determine not to trigger feedback based on based on a WTRU-predicted value being less than (or greater than) an offset when compared to a network predicted value (e.g., for a same confidence percentage).

For example, a WTRU 102 may, for a given timestep, trigger feedback based on a WTRU-predicted value being less than (or greater than) an offset when compared to a network predicted value (e.g., for a different confidence percentage) for (e.g., only) an upper boundary.

For example, a WTRU 102 may, for a given timestep, trigger feedback based on a WTRU-predicted value being less than (or greater than) an offset when compared to a network predicted value (e.g., for a different confidence percentage) for (e.g., only) a lower boundary.

For example, a WTRU 102 may, for a given timestep, determine not to trigger feedback based on based on a WTRU-predicted value being less than (or greater than) an offset when compared to a network predicted value (e.g., for a different confidence percentage).

### WTRU-Triggered Handover

In certain representative embodiments, a WTRU 102 may determine to trigger a handover within a reconfiguration window (e.g., a time interval corresponding to 1208 to 1210 in FIG. 12).

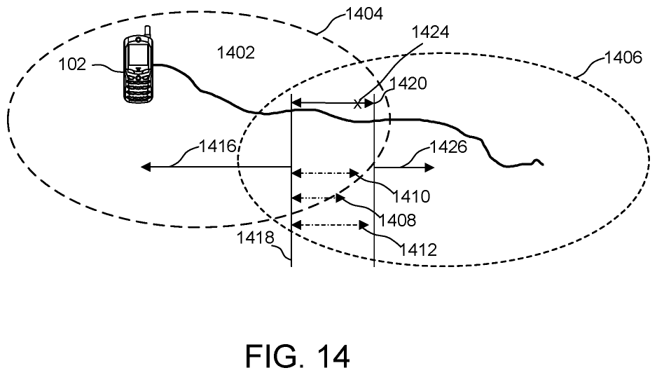

FIG. 14 is a system diagram illustrating an overview of what occurs over time to a WTRU in the context of a handover utilizing predictions. FIG. 14 is presented in a format similar to FIG. 7 for purposes of comparison. In certain representative embodiments, a WTRU 102 may determine to execute (e.g., trigger) a handover based on predictions as describe herein.

In FIG. 14, a WTRU 102 may have a trajectory 1402 corresponding to the WTRU 102 moving across a first cell 1404 and then to a second cell 1406. Time intervals 1408, 1410 and 1412 may correspond to time spans for the AI/ML models in FIGS. 9, 10 and 11 to generate respective predictions.

For example, similarly to the time interval 708 in FIG. 7, a time interval 1416 in FIG. 14 represents the time during which the WTRU's serving cell is the first cell 1404 and both the WTRU's uplink and downlink transmissions are towards the first cell 1404. Also, similarly to the time 710 in FIG. 7, at a time 1418 in FIG. 14, the WTRU 102 receives, from the network, a HO command or determines that the triggering conditions for a previously configured CHO are fulfilled.

A time interval 1420 in FIG. 14 represents a period during which the WTRU 102 waits (e.g., within a time duration otherwise referred to as the reconfiguration window or HO window) before executing the HO or CHO. Specifically, instead of executing the HO or CHO immediately as in a legacy HO or CHO, the WTRU 102 will decide when exactly to execute the HO within this reconfiguration window 1420. The duration of the reconfiguration window 1420 may be provided by the network (e.g., based on network prediction of serving and/or target cell signal levels) and/or determined by the WTRU 102 (e.g., using actual or predicted measurements of serving and/or target cell signal levels). For example, the exact moment where the HO is executed may depend on the current and predicted UL buffer conditions (e.g., conditions regarding the bearers that are delay sensitive and whose QoS's might be impacted considerably by any HO interruption).

In FIG. 14, a time 1424 represents an example point at which the WTRU may make the decision to execute the HO. In this particular example, the time 1424 may correspond to a time for the AI/ML model of FIG. 10 to make a UL buffer status prediction.

A time interval 1426 in FIG. 14 represents a period during which the WTRU's serving cell is the second cell 1406 and both its uplink and downlink transmissions are towards the second cell 1406.

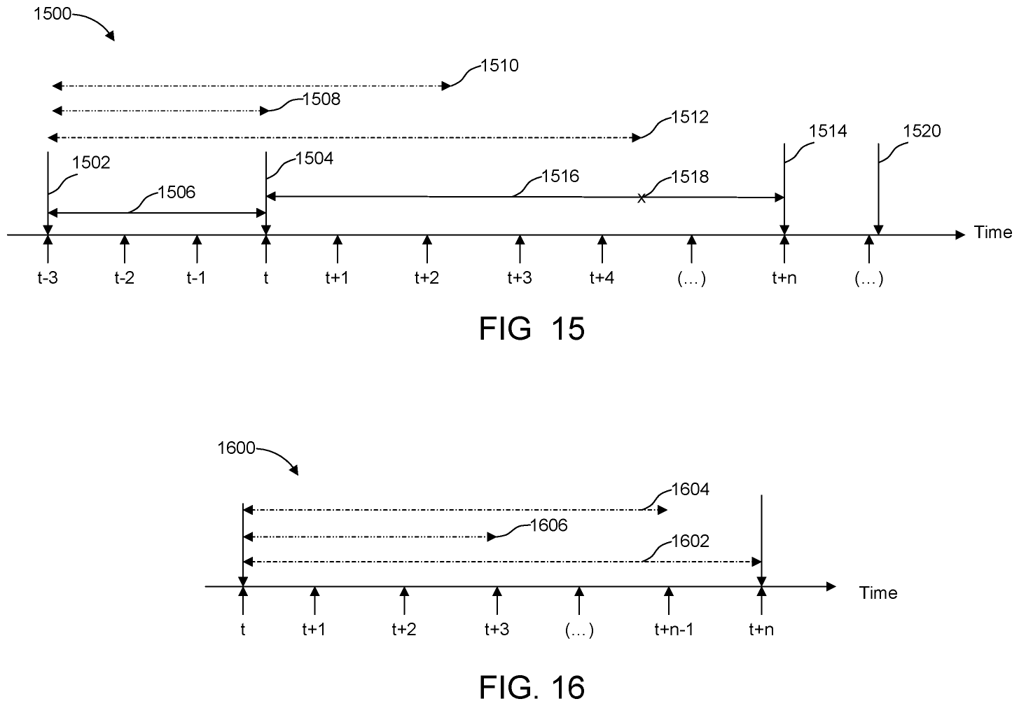

FIG. 15 is a timing diagram 1500 illustrating an example of a handover procedure utilizing predictions.

At 1502, the network will predict (e.g., based on air interface measurements prediction) the possible reconfiguration window for the WTRU 102 to perform a HO. The network will then send (e.g., at time t−3) an RRC Reconfiguration message (or any other message) to the WTRU with any required configuration aspects.

At 1504, the WTRU 102 may start a reconfiguration window (e.g., 1420 in FIG. 14), such as based on the RRC Reconfiguration message at 1502. During the time interval 1506, the WTRU may send measurement report messaging (or any other message) to the network which provides feedback, such as on the network predicted reconfiguration window. During this period between 1502 and 1504, the WTRU 102 may be required by the network to (or may, by an internal decision to) trigger predictions that can either (a) assist with validating the network received information and/or (b) assist with its own internal decision process. Therefore, during the time period at 1506 between the times at 1502 and 1504, the WTRU 102 may trigger any prediction of future values for any quantity that would be relevant for such purpose. For example, the WTRU 102 may trigger one or more of the AI/ML models, such as in FIGS. 9, 10, and/or 11 to perform their predictions). In certain representative embodiments, as shown in FIG. 15, the WTRU may obtain predictions for time spans 1508, 1510, and/or 1512 from the AI/ML models. In other representative embodiments, the WTRU may obtain predictions starting at 1504 (e.g., time ‘t’ in FIG. 15).

In FIG. 15, a time (e.g., t+n) at 1514 denotes an end of the reconfiguration window 1516 (e.g., from the start at time ‘t’ to the end at time ‘t+n’).

Within the reconfiguration window 1516, the WTRU 102 will trigger the HO. For purposes of explanation, the reconfiguration window is referred to herein as a time window. In other examples, the reconfiguration window may be defined in other ways including any of: (i) a time range, (ii) a delta (e.g., from t−3 or t), (iii) a geo-location area (e.g., defined by any of GPS, x/y/z coordinate system, indoor positioning system, etc.), (iv) a delta from the WTRU's position (e.g., using any of GPS, x/y/z coordinate system, indoor positioning system, etc.), (v) a distance to the current location when the configuration is received, (vi) a distance to the location that the WTRU will be at a given time (e.g., t−3 or t), (vii) a distance to the location that the WTRU will be at any other time step, and/or (viii) an air interface difference between any time steps (e.g. [RSRP1@t; RSRP2] OR [RSRQ1; RSRQ2], etc.).

In FIG. 15, the WTRU may perform the HO at 1518. For example, this may correspond to the time at which the WTRU initiates the HO, which will be some short interval after the WTRU makes the decision to perform the HO.

Finally, the WTRU transmits feedback information to the network at 1520. The providing of feedback information from the relevant feedback process may occur at a time after HO is performed and/or after the end of reconfiguration window (e.g., after the time ‘t+n’).

### Examples of WTRU Triggered Handovers

FIG. 16 is a timing diagram 1600 illustrating examples of handover triggers for different HO types and WTRU prediction lengths.

In certain representative embodiments, the network may indicate information association with a reconfiguration window to a WTRU 102. In FIG. 16, the reconfiguration window may be provided for a time interval [t;t+n]. The WTRU 102 is expected by the network to perform the HO at any time within this window. As a first example, a WTRU 102 may determine to perform (e.g., trigger) the HO at a time ‘t+3’ as shown at 1602. This may be applicable for any HO type.

As a second example, the reconfiguration window may be initially provided for a time interval [t;t+n]. The WTRU 102 may assess and correct the reconfiguration window based on its own predictions. The WTRU 102 may decide upon a better reconfiguration window is [t;t+n−1]. For instance, the WTRU may have received a RRC reconfiguration message implying (e.g. indicating) HO and may have triggered predictions that lead to a decision that the window should be [t;t+n−1] at 1604.

As a third example, the WTRU may receive a RRC reconfiguration implying (e.g., indicating) DAPS HO and the reconfiguration window may be provided for a time interval [t;t+n]. The WTRU may decide to perform (e.g., trigger) an UL switch and request to release the source cell at a time ‘t+3’.

### WTRU Triggers

In certain representative embodiments, a WTRU 102 may determine a particular time to trigger a HO within a reconfiguration window.

As shown in FIG. 16, the reconfiguration window may be provided for a time interval [t;t+n].

The WTRU may decide to perform a HO (or an UL switch in the case of DAPS HO) when the first one of any of one or more conditions listed below is/are met. For example, the one or more conditions may be provided in terms of UL buffer related criteria, air interface radio conditions related, and/or QoS related criteria. The conditions can be related to current conditions, conditions predicted by the network, and/or conditions predicted by the WTRU. The conditions may be specified, predetermined and/or provided by the network (e.g., as part of the reconfiguration information).

In certain representative embodiments, one or more of the conditions may be related to current UL buffer status (e.g., level, value, quantity). For example, a condition may be any of: (i) the current UL buffer for a particular data radio bearer, PDU session, and/or QFI falls below a threshold; (ii) the current UL buffer for a set of data radio bearers, PDU sessions, and/or QFIs falls below a threshold; (iii) the current UL buffer for any combination of any data radio bearer(s), any PDU session(s), and/or QFI(s) falls below a threshold; (iv) the current UL buffer levels fall by more than a specific rate for any combination listed in (i), (ii) or (iii), such as for any consecutive time step; and/or (v) the current UL buffer levels fall by more than a specific rate for any combination listed in in (i), (ii) or (iii), such as for any non-consecutive time steps for any given set of time steps (e.g., QFIx falls by more than a specific rate over a period of 3 time steps).

In certain representative embodiments, one or more of the conditions may be related to predicted UL buffer status (e.g., level, value, quantity). For example, a condition may be any of: (i) the current UL buffer is less than or equal to minimum value of the network predicted UL buffer; the current UL buffer level is less than or equal to minimum value of the WTRU predicted UL buffer; (ii) the current UL buffer level than or equal to a minimum value of the average between WTRU and network predicted UL buffer levels for a given time step; (iii) the current UL buffer level is less than or equal to a minimum value of the average between WTRU and network predicted UL buffer levels for two different time steps (e.g., where one time step relates to the WTRU predicted minimum value and the second time step relates to the network predicted minimum value); (iv) the current UL buffer less than or equal to minimum value of the predicted UL buffer minus a delta_xy (e.g., where that delta is associated with a certain prediction accuracy, such as where the minimum predicted UL buffer value is y bytes with x % accuracy, then there is a delta_xy associated with the triggering criteria); (v) the current UL buffer level less than or equal toa minimum value of the predicted UL buffer level minus a delta_xyz (e.g., where that delta is associated with certain radio conditions, such as where the minimum predicted UL buffer value is y bytes with RSRP=x OR RSRQ=x OR RSRQ=x AND RSRP=z, then there is a delta_xyz associated with the triggering criteria); and/or (vi) the current UL buffer level less than or equal to minimum value of the predicted UL buffer minus a delta_xyz (e.g., where that delta is associated with certain QoS conditions, such as the minimum predicted UL buffer value is y bytes with packet error rate=x OR current packet delay=x OR packet error rate=x AND packet delay=z, then there is a delta_xyz associated with the triggering criteria).

In certain representative embodiments, one or more of the conditions may be related to radio conditions (e.g., level, value, quantity). For example, a condition may be any of: (i) the current radio condition (e.g., RSRP) falls below a threshold; (ii) the current radio condition (e.g., RSRP) decreases at more than a certain rate between any consecutive time steps; (iii) the current radio condition (e.g., RSRP) decreases more than a certain rate between any non-consecutive time steps (e.g., RRP or SNR falling by more than a specific rate over a period of 3 time steps); and/or (iv) any combination of air interface measurements and thresholds or drop rates.

In certain representative embodiments, one or more of the conditions may be related to QoS (e.g., level, value, quantity). For example, a condition may be any of: (i) UL throughput falls below a threshold; (ii) UL throughput decreases by a certain rate over consecutive timesteps; (iii) UL throughput decreases by a certain rate over non consecutive timesteps; (iv) DL throughput falls below a threshold; (v) DL throughput decreases by a certain rate over consecutive timesteps; (vi) DL throughput decreases by a certain rate over non consecutive timesteps; (vii) a number of retransmissions at any applicable layer is higher than a threshold; (viii) a number of retransmissions at any applicable layer increases by a certain rate over any consecutive timesteps; (ix) a number of retransmissions at any applicable layer increases by a certain rate over non consecutive timesteps; (x) packet delay becomes higher than a threshold; (xi) packet delay increases by a certain rate over any consecutive timesteps; (xii) packet delay increases by a certain rate over any non-consecutive timesteps; (xiii) packet error rate becomes higher than a threshold; (xiv) packet error rate increases at a certain rate over any consecutive timesteps; and/or (xv) packet error rate increases at a certain rate over any non-consecutive timesteps.

In certain representative embodiments, a WTRU 102 may combine any of the above listed conditions to perform the HO (e.g., in any possible combination).

In certain representative embodiments, if none of the conditions are met (or otherwise indicated to be applicable) and the end of the reconfiguration window is reached, the WTRU 102 will trigger the HO at the end of the reconfiguration window (e.g., the time ‘t+n’ in FIG. 16).

Feedback As shown in FIG. 15, for example, a WTRU 102 may send feedback to the network between times at 1502 and 1504 via measurement reports (or other messages), and also at 1520, after the HO process is complete. In the case of the timing at 1520, the WTRU will have to send this feedback to the target RAN node, and this node, in turn, will have to send it to the source RAN node. Currently, 5G specifications do not keep the WTRU context (e.g., different protocol stack layers configuration) alive at the source node after the HO, but this could be a future option. Therefore, it is considered that feedback sent at 1520 may be sent to both the source and target RAN nodes. In case the feedback is sent to the target, then the target would have to forward the information to the source RAN node.

Pre-Process Feedback In certain representative embodiments, the feedback that the WTRU sends to the network between the time at 1502 and the time at 1504 may include full predictions (e.g., a prediction value per each time step) that the network required the WTRU to perform, such as any kind of prediction described herein. In certain representative embodiments, the feedback that the WTRU sends to the network between the time at 1502 and the time at 1504 may include a subset of values only. In certain representative embodiments, the feedback that the WTRU sends to the network between the time at 1502 and the time at 1504 may include a subset of values for QoS related metrics, one value for a radio interface measurement (e.g., RSRP), and/or another subset of values for UL buffers. In certain other embodiments, the feedback may include any combination of QoS, radio interface, and/or UL buffer information, such as for a single time point, a set of time points, and/or a subset of time points.

In certain representative embodiments, the network may not send any configuration information to the WTRU and the WTRU may be configured (e.g., implicitly by configuration absence) to trigger predictions and perform the whole process autonomously.

In certain representative embodiments, the network may configure the WTRU to use a particular reconfiguration window, and send information on one, some, or all listed prediction values, as feedback information before the reconfiguration window starts.

### Post-Process Feedback

In certain representative embodiments, the feedback that the WTRU sends to the network after the HO is complete (e.g., after the reconfiguration window at 1520) may include any of the following. For example, the feedback may include any of:
(i) a number of packets transmitted to the source RAN node after the reconfiguration window starts but before HO;
(ii) a number of packets transmitted to the source RAN node after the reconfiguration window starts and until the feedback is sent;
(iii) a number of packets re-transmitted to the source RAN node before HO;
(iv) a number of packets re-transmitted to the source RAN node after the reconfiguration window starts and until the feedback is sent;
(v) a UL delay budget available per time step;
(vi) a delay budget available per time step group (where a time step group may have any granularity);
(vii) an average UL delay budget per time step group (where a time step group may have any granularity) after the reconfiguration window starts but before HO;
(viii) an average UL delay budget per time step group (where a time step group may have any granularity) after the reconfiguration window starts and until the feedback is sent;
(ix) same as in (v) to (viii) but for UL packet delay;
(x) same as in (v) to (viii) but for UL packet error rate;
(xi) same as in (v) to (viii) but for UL throughput;
(xii) same as in (v) to (viii) but for DL throughput;
(xiii) same as in (v) to (viii) but for any number of retransmitted packets in the UL and/or DL (e.g., at the source RAN node);
(xiv) same as in (v) to (viii) but for UL buffer levels (e.g., for one, all, a subset, or a combination of any data radio bearer(s), PDU session(s), and/or QFI(s)), such as may be averaged over time step group or not, including after the reconfiguration window starts but before HO and/or after the reconfiguration window starts and until the feedback is sent; and/or
(xv) Same as in items 5-8 but for any air interface measurements, averaged over time step group or not, both after the reconfiguration window starts but before HO and/or after the reconfiguration window starts and until the feedback is sent.

### Layer 3 Procedures

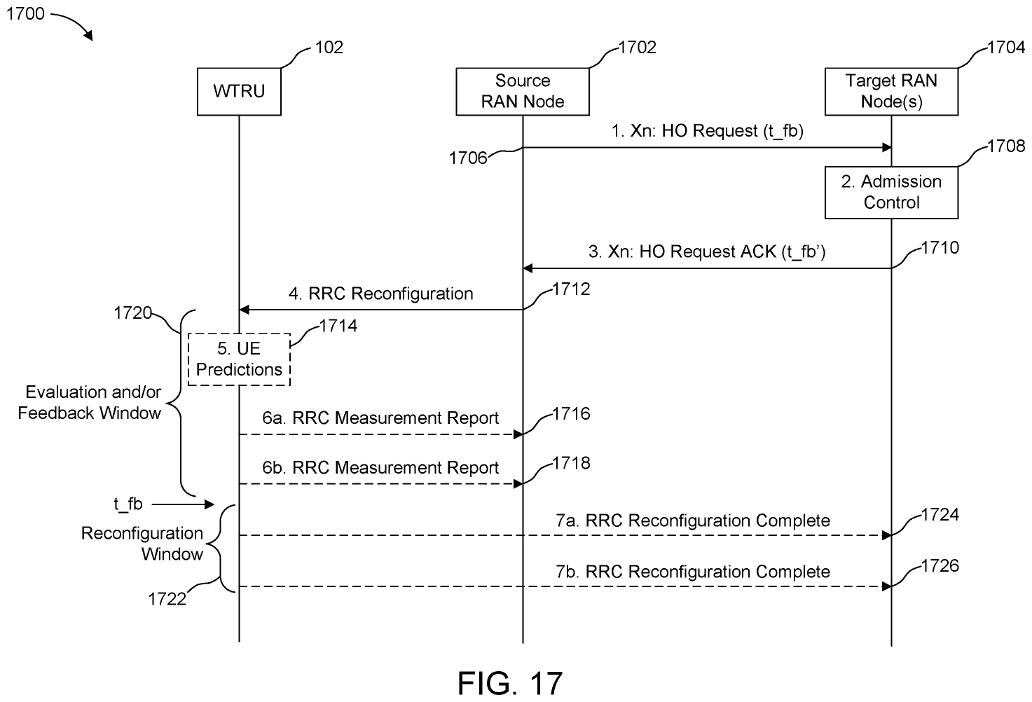

FIG. 17 is a flow diagram 1700 illustrating an example of a L3 communication procedure in accordance with certain embodiments. In certain representative embodiments, a source RAN node 1702 (e.g., gNB 180) may determine that a WTRU 102 to execute a HO to a target RAN node 1704 (e.g., gNB 180) as described herein at 1706. For example, the source RAN node 1702 may request (e.g., send a HO request via an Xn interface) the target RAN node 1704 (e.g., gNBs 180), or multiple target RAN nodes (e.g., gNBs) in the case of a CHO, to accommodate the WTRU 102. The source RAN node 1702 may include a time value (e.g., t_fb) associated with a starting point after which the WTRU 102 may determine to execute the HO.

In certain representative embodiments, at 1708, the one or more target RAN nodes 1704 may perform admission control after receiving the HO request. For example, an (e.g., implicit or explicit) indication of a time value (e.g., t_fb) associated with (e.g., a start of) a time interval in which the HO may be executed may help resolve the resource reservation problem mentioned above, such as for the CHO type of HO. The target RAN node(s) 1704 may use the received request to identify whether the WTRU 102 may be accommodated at that time. For example, the target RAN node(s) 1704 may leverage AI/ML techniques for predicting a future resource status. In this manner, the admission control process may be enhanced.

In certain representative embodiments, any of the target RAN nodes 1704 may rely on historical information from the WTRU 102 to leverage AI/ML techniques, such as to predict the time interval for execution of the HO (e.g., t_fb). Any of the target RAN nodes 1704 may provide feedback information (e.g., prior to the HO request) on this prediction at 1710. The feedback information may be sent to the source RAN node 1702 (e.g., as a HO request acknowledgment message using the Xn interface). For example, the feedback information may include a time value t_fb′. The time value may be a separate time value or a delta to the received t fb.

In certain representative embodiments, the source RAN node 1702 may configure the WTRU 102 with an HO command as described herein. For example, the WTRU 102 may receive a RRC reconfiguration at 1712 in FIG. 17. For example, the reception by the WTRU 102 may mark a start of an evaluation and/or feedback window associated with the HO command.

For example, the network (e.g., source RAN node 1702) may instruct the WTRU 102 to perform inferences and generate predictions at 1714 in FIG. 17. Input information for generating the WTRU-predictions may be included in the RRC reconfiguration at 1712.

In certain representative embodiments, the WTRU 102 may send measurement information to the source RAN node, such as two or more RRC measurement reports at 1716 and 1718 in FIG. 17. For example, each of the measurement reports may be a message that the WTRU 102 may send to the network during an evaluation and/or feedback window 1720. For example, the measurement reporting may be optional in some cases, and the feedback information may be triggered at the WTRU 102 as described herein.

In certain representative embodiments, at the end of the evaluation and/or feedback window (e.g., at t_fb), a reconfiguration window 1722 may start. During the reconfiguration window 1722, the WTRU 102 may determine whether or not (and when) to execute the HO within the reconfiguration window 1722. For example, the WTRU 102 may execute the HO at a first time during the reconfiguration window and may send a RRC reconfiguration complete message to a target RAN node at 1724. As another example, the WTRU 102 may execute the HO at a second time during the reconfiguration window and may send a RRC reconfiguration complete message to a target RAN node at 1726. While FIG. 17 shows multiple RRC reconfiguration complete messages, the messaging at 1724 and 1726 is to illustrate that the WTRU 102 may trigger a conclusion of the HO at different times during the reconfiguration window 1722 as described herein.

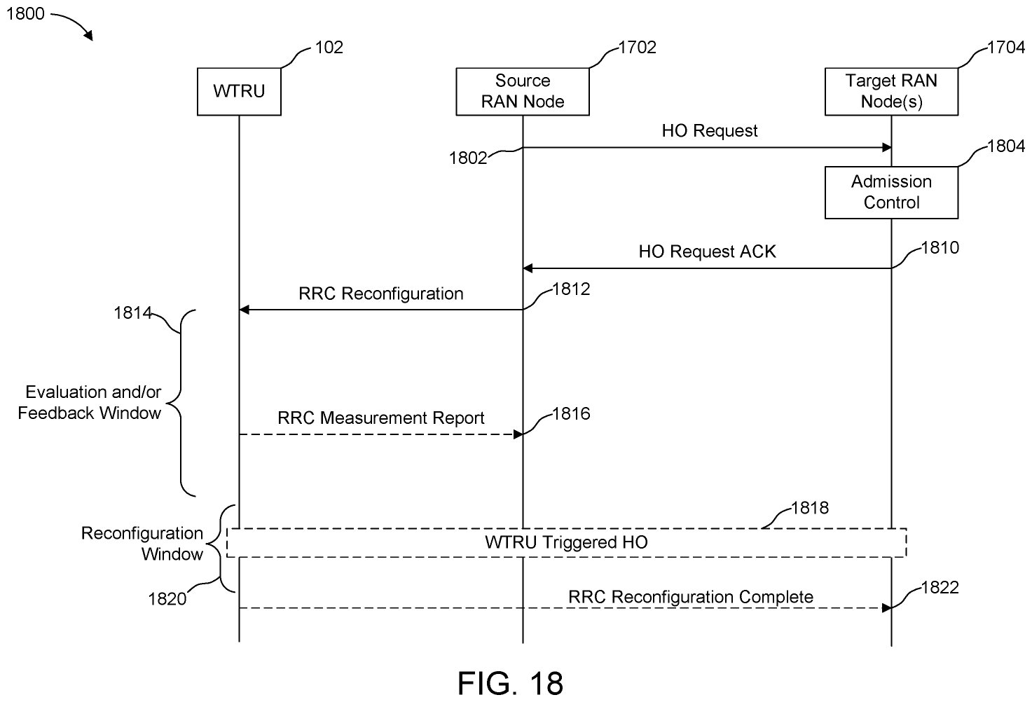

FIG. 18 is a flow diagram 1800 illustrating an example of a layer 3 (L3) communication procedure in accordance with certain embodiments.

At 1802, the source RAN node 1702 decides to execute a procedure in which the WTRU 102 will determine when to perform an HO (e.g., CHO) in accordance with the principles described hereinabove and requests the target node(s) 1704 for HO (e.g., CHO) to accommodate the WTRU. The source RAN node 1702 may have already attained a reconfiguration time window and, if so, may include this information along with any predictions in the HO request sent to the target node(s) 1704 at 1802.

At 1804, the admission control function at the target RAN node(s) 1704 may be modified because, although the target node 1704 might receive a reconfiguration window [t;t+n] from the WTRU 102 within the HO Request message and accept that window, it alternately might shorten or increase the reconfiguration window. For example, it may decrease/increase the window in a non-negotiable way. Alternately, it may only send recommendations for increasing or decreasing the window. In some embodiments, it may send back a completely new window specification. In other embodiments, it may send back a delta value to be applied from the end of the originally specified window or a delta value to be applied from the beginning of the originally specified window. In yet other embodiments, it may send a time shift value (e.g., if the originally specified window was [t;t+n], the target node may shift the window two seconds later [t+2; t+n+2]). The target node may include any such window modification information at 1810.

At 1810, the target RAN node(s) 1704 may send an HO request ACK message with the modified window or any feedback to the source node 1702 in any of the manners described herein.

At 1812, the source RAN node 1702 may send an RRC Reconfiguration message to the WTRU 102 to reconfigure the WTRU 102, such as in accordance with any of the embodiments described in FIG. 15. The reception of the reconfiguration information at 1812 marks the start of an evaluation and feedback window 1814.

At 1816, the WTRU may optionally send feedback to the network as described herein.

At 1818, using any of the triggers described herein, the WTRU 102 may, at any point within a reconfiguration widow 1820, trigger the HO or uplink switch (e.g., in the DAPS case).

At 1820, the WTRU 120 transmits an RRC reconfiguration complete message to the source node 1702. The RRC reconfiguration message may include any of the feedback information detailed herein.

At 1822, the WTRU 102 may use a next measurement report or any other message to send feedback to the network via the target node 1704. This message may additionally be directed to the source RAN node 1702, in which case there would be no need for the target node 1704 to forward the feedback information to the source node 1702.

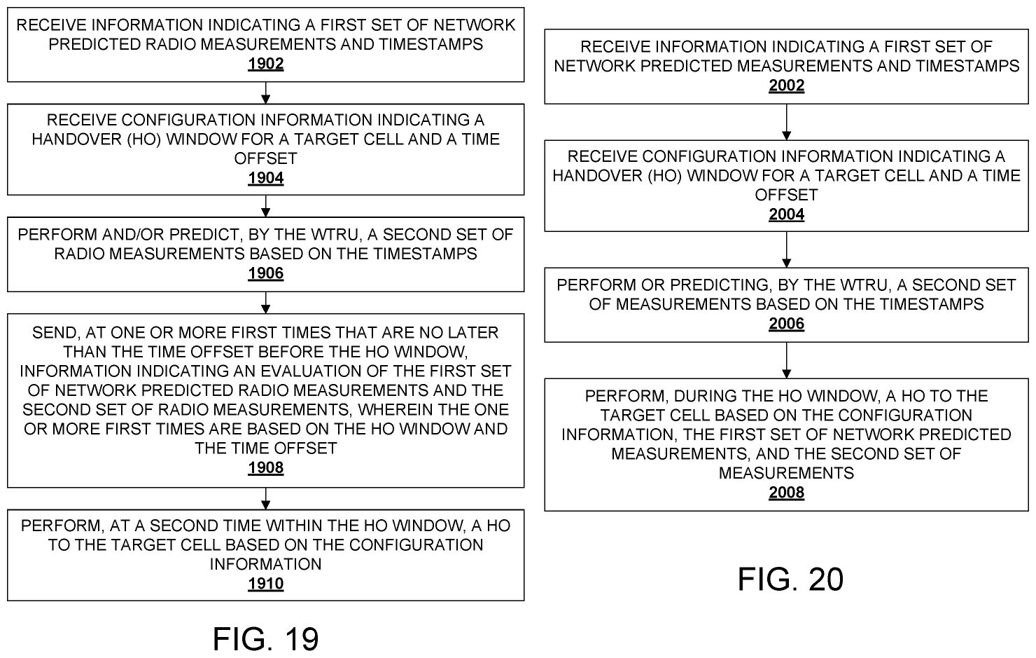

In certain representative embodiments, features described in FIGS. 19-25 may be combined, omitted and/or modified, in part or in whole, as described herein.

FIG. 19 is a procedural diagram illustrating an example feedback and HO procedure for a WTRU 102. At 1902, a WTRU 102 may receive (e.g., from a source cell) information indicating a first set of network predicted radio measurements and timestamps. At 1904, the WTRU 102 may receive configuration information indicating a handover (HO) window (e.g., reconfiguration window) for a target cell and a time offset. For example, the timestamps received at 1902 may correspond to a time interval which is before the HO window. At 1906, the WTRU may perform and/or predict a second set of radio measurements based on the timestamps. At 1908, the WTRU 102 may send, at one or more first times that are no later than the time offset before the HO window, information indicating an (e.g., one or more) evaluation of the first set of network predicted radio measurements and the second set of radio measurements. For example, the one or more first times may be based on the HO window and the time offset. At 1910, the WTRU 102 may perform, at a second time within the HO window, a HO to the target cell based on the configuration information.

In certain representative embodiments, the information at 1902 and 1904 may be received together in a RRC message.

In certain representative embodiments, the information indicating the HO window may include a start time of the HO window and an end time of the HO window.

In certain representative embodiments, the HO window is a time interval (e.g., for executing a HO using the configuration information received at 1904).

In certain representative embodiments, the timestamps received at 1902 are no later than the time offset (e.g., t_fb) before the HO window. For example, a latest timestamp may correspond with a latest measurement of the first set of measurements In certain representative embodiments, the HO window may be indicated as a number of milliseconds, slots, or symbols.

In certain representative embodiments, the HO is a dual access protocol stack (DAPS) HO or a conditional HO as described herein.

In certain representative embodiments, the information indicating the HO window and/or the time offset may be included in a radio resource control (RRC) message (e.g., a RRC reconfiguration message).

In certain representative embodiments, the WTRU 102 may determine the one or more first times based on the HO window and the time offset. For example, the WTRU 102 may send evaluation information at a (e.g., last) first time which is no later than the time offset before the HO window.

In certain representative embodiments, the WTRU 102 may determine the second time (e.g., at which the HO is executed) based on a set of uplink (UL) buffer measurements satisfying a threshold. For example, the WTRU 102 may use UL buffer measurements and other WTRU measurements (e.g., radio and/or QoS measurements) as described herein to determine the second time (e.g., trigger the HO in the HO window).

In certain representative embodiments, the WTRU 102 may perform and/or predict, by the WTRU, the set of UL buffer measurements.

In certain representative embodiments, the set of UL buffer measurements may be associated with one or more data radio bearers, one or more protocol data unit (PDU) sessions, and/or one or more Quality of Service flow identifiers (QFIs).

In certain representative embodiments, the WTRU 102 may determine (e.g., perform) the set of UL buffer measurements during a time interval between a start of the HO window and the second time.

FIG. 20 is a procedural diagram illustrating an example HO procedure for a WTRU 102. At 2002, the WTRU 102 may receive information indicating a first set of network predicted measurements and timestamps. At 2004, the WTRU may receive (e.g., from a source cell) configuration information indicating a HO window for a target cell and a time offset. For example, the information at 2002 and 2004 may be received together in a RRC message (e.g., RRC reconfiguration message). At 2006, the WTRU 102 may perform and/or predict a second set of measurements based on the timestamps received at 2002. At 2008, the WTRU 102 may perform, during the HO window, a HO to the target cell based on the configuration information, the first set of network predicted measurements, and the second set of measurements. For example, the HO may be triggered using the first set and the second set of measurements, and the execution of the HO may be performed according to the configuration information.

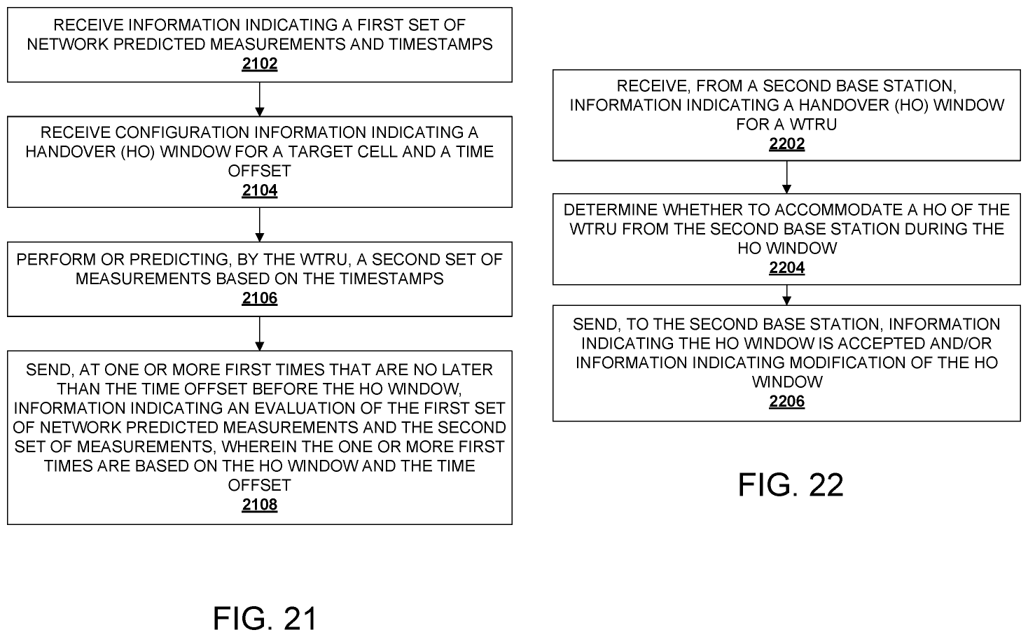

FIG. 21 is a procedural diagram illustrating an example feedback procedure for a WTRU 102. At 2102, the WTRU 102 may receive information indicating a first set of network predicted measurements and timestamps. At 2104, the WTRU 102 may receive (e.g., from a source cell) configuration information indicating a HO window for a target cell and a time offset. For example, the information at 2102 and 2104 may be received together in a RRC message (e.g., RRC reconfiguration message). At 2106, the WTRU 102 may perform and/or predict a second set of measurements based on the timestamps. At 2108, the WTRU 102 may send, at one or more first times that are no later than the time offset before the HO window, information indicating an (e.g., one or more) evaluation of the first set of network predicted measurements and the second set of measurements. For example, the one or more first times may be based on the HO window and the time offset. For example, the first times may (e.g., each be) before (e.g., no later than) a time equal to the time offset before the start of the HO window.

FIG. 22 is a procedural diagram illustrating an example admission control procedure for a first base station (e.g., gNB 180). At 2202, the first base station (e.g., associated with a target cell) may receive, from a second base station (e.g., associated with a source cell), information indicating a handover (HO) window for a WTRU 102. For example, the first base station may receive a HO request as described herein. At 2204, the first base station may determine whether to accommodate a HO of the WTRU 102 from the second base station during the HO window. For example, the first base station may determine whether sufficient resources will be available to accommodate the WTRU 102 when the HO is to be performed (e.g., during the HO window). Such resources may be reserved as part of the determination at 2204. At 2206, assuming the HO request is acceptable, the first base station may send, to the second base station, information indicating the HO window is accepted and/or information indicating modification of the HO window. For example, the first station may send a HO request acknowledgment message to the second base station which includes information indicating modification of the HO window.

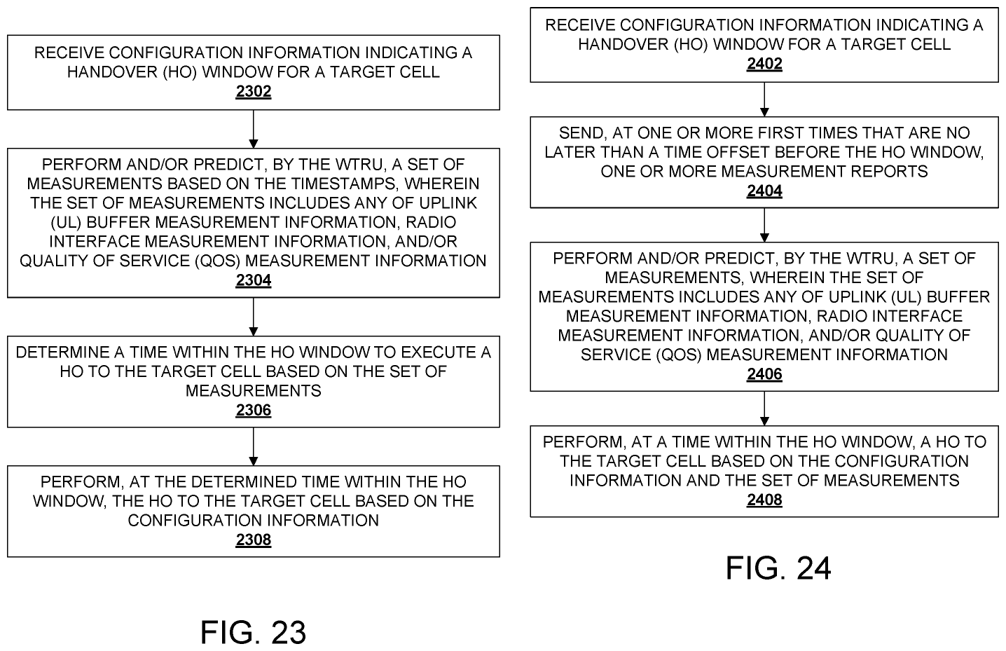

FIG. 23 is a procedural diagram illustrating an example HO procedure for a WTRU 102. At 2302, the WTRU 102 may receive (e.g., from a source cell) configuration information indicating a handover (HO) window for a target cell. At 2304, the WTRU 102 may perform or predict a set of measurements based on the timestamps. For example, the set of measurements may include any of uplink (UL) buffer measurement information, radio interface measurement information, and/or Quality of Service (QOS) measurement information. For example, the set of measurements may correspond to measured quantities at the indicated timestamps, respectively. At 2306, the WTRU 102 may determine a time within the HO window to execute (e.g., trigger) a HO to the target cell based on the set of measurements. For example, the set of measurements may be compared against another set of network predicted measurements. Various examples of WTRU evaluation and triggers are described herein. At 2308, the WTRU 102 may perform, at the determined time within the HO window, the HO to the target cell based on the configuration information.

In certain representative embodiments, the WTRU 102 may provide pre-process and/or post-process feedback information relating to the HO and/or the HO window. For example, the feedback information may include evaluation associated with the network predicted measurements and/or the WTRU (e.g., predicted and/or performed) measurements.

FIG. 24 is a procedural diagram illustrating an example HO procedure for a WTRU 102. At 2402, the WTRU 102 may receive configuration information indicating a handover (HO) window for a target cell. At 2404, the WTRU 102 may send, at one or more first times that are no later than a time offset before the HO window, one or more measurement reports. For example, at each first time, the WTRU may send a respective measurement report (e.g., associated with one or more measurements). At 2406, the WTRU 102 may perform and/or predict a set of measurements. For example, the set of measurements may include any of (e.g., a set of) uplink (UL) buffer measurement information, (e.g., a set of) radio interface measurement information, and/or (e.g., a set of) Quality of Service (QOS) measurement information. At 2408, the WTRU 102 may perform, at a time within the HO window, a HO to the target cell based on the configuration information and the set of measurements. For example, the time at which the HO is performed may be based on the set of measurements obtained at 2406.

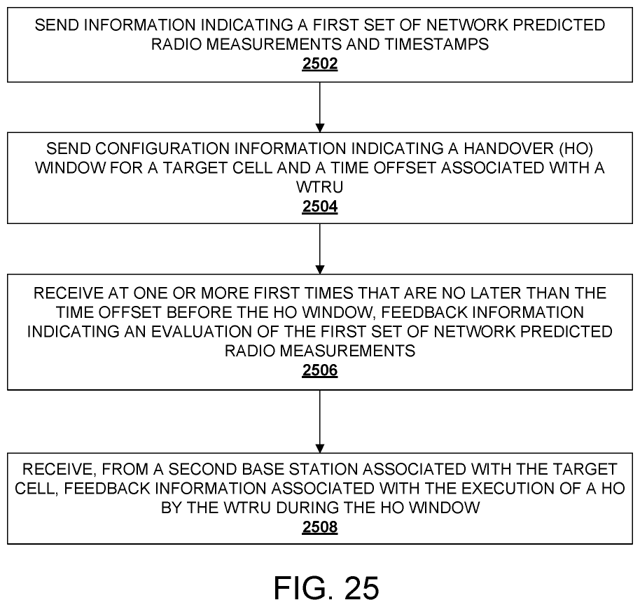

FIG. 25 is a procedural diagram illustrating an example feedback procedure for a base station (e.g., associated with a source cell). At 2502, the base station may send (e.g., to a WTRU 102) information indicating a first set of network predicted radio measurements and timestamps. The base station may send, at 2504, configuration information indicating a handover (HO) window for a target cell and a time offset. For example, the information sent at 2502 and 2504 may be included in a RRC message (e.g., RRC reconfiguration message). At 2506, the base station may receive (e.g., pre-process) feedback information. For example, the base station may receive (e.g., from the WTRU 102), at one or more first times that are no later than the time offset before the HO window, feedback information indicating an evaluation of the first set of network predicted radio measurements. At 2508, the base station may receive, from a second base station associated with the target cell, (e.g., post-process) feedback information associated with the execution of a HO by the WTRU 102 during the HO window.

In certain representative embodiments, features described in FIGS. 19-25 may be combined, omitted and/or modified, in part or in whole, as described herein.

In certain representative embodiments, a WTRU 102 may implement a method or perform a procedure which includes to receive information indicating a handover (HO) command from a first base station (e.g., associated with a source cell). The WTRU 102 may receive information indicating a first set of network predicted measurements associated with the HO command. The WTRU 102 may obtain a second set of measurements associated with one or more second base stations (e.g., candidate cells). On condition that the first set of network predicted measurements and the second set of measurements satisfy one or more first criteria, the WTRU 102 may perform a HO to one of the second base stations (e.g., associated with a target cell).

For example, the WTRU 102 may receive one or more RSs from the one or more second base stations. The second set of measurements may be based on the received one or more RSs from the one or more second base stations.

For example, the WTRU 102 may predicting one or more RS values associated with the one or more second base stations. The obtained second set of measurements may be based on the predicted one or more RS values.

For example, the information indicating the HO command may be a reconfiguration message. The reconfiguration message may include information indicating any of (i) the one or more second base stations, (ii) a first time interval associated with the first set of network predicted measurements and/or the second set of measurements, (iii) a second time interval for executing the HO, (iv) the one or more first criteria, and/or (v) a confidence interval associated with the first time interval and/or the first set of network predicted measurements.

For example, the execution of the HO may include performing a random access channel (RACH) procedure with the one of the second base stations.

For example, the execution of the HO may include sending a reconfiguration complete message to the one of the second base stations.

For example, the WTRU 102 may on condition that the first set of network predicted measurements and/or the second set of measurements satisfy one or more second criteria, send feedback information associated with at least the second set of measurements to the first base station.

For example, the WTRU 102 may, on condition that the first set of network predicted measurements and the second set of measurements do not satisfy the one or more first criteria, send feedback information associated with at least the second set of measurements to the first base station.

For example, the HO command may be any of a legacy HO command, a dual access protocol stack (DAPS) HO command, or a conditional HO (CHO) command.

For example, the WTRU 102 may receive information indicating one or more configurations of the RSs.

For example, the WTRU 102 may receive information indicating a measurement configuration for the second set of measurements.

For example, the WTRU 102 may receive information indicating a reporting configuration for the feedback information.

For example, the one or more predicted RS values associated with the one or more second base stations may (e.g., be determined by the WTRU to) satisfy a configured confidence interval.

For example, the one or more second criteria may include at least one of the second set of measurements falling outside of a window corresponding to a configured confidence interval.

For example, the one or more second criteria may include a difference between at least one of the second set of measurements and at least one of the first set of network predicted measurements, for a same time point and/or a same confidence interval, being greater than a threshold value.

For example, the threshold value may be associated with an upper limit of the confidence interval.

For example, the threshold value may be associated with a lower limit of the confidence interval.

For example, the one or more first criteria may include a difference between at least one of the second set of measurements and at least one of the first set of network predicted measurements, for a same time point and/or a same confidence interval, being less than a threshold value.

For example, the threshold value may be associated with an upper limit of the confidence interval.

For example, the threshold value may be associated with a lower limit of the confidence interval.

In certain representative embodiments, a base station (e.g., associated with a source cell) may send, to one or more other base stations, a handover (HO) request which includes information indicating a time interval of a HO of a WTRU. The base station may send, to the WTRU, information indicating a HO command. The base station may obtain a first set of network predicted measurements associated with the HO command. The base station may send, to the WTRU, the first set of network predicted measurements. For example, the WTRU may use the first set of network predicted measurements as described herein.

For example, the base station may receive, from the WTRU, feedback information associated with at least a second set of measurements obtained by the WTRU based on the HO command.

For example, the sending of the first set of network predicted measurements may include a confidence interval for which the first set of network predicted measurements were obtained.

For example, the feedback information may be received from the WTRU on condition that one or more criteria associated with the confidence interval are not satisfied, such as in cases where the HO command is not executed by the WTRU (e.g., within the HO window).

In certain representative embodiments, a WTRU 102 may implement a method or perform a procedure which includes to receive an instruction, from a network, to perform a Handover (HO). The WTRU 102 may receive, from the network, configuration information for a reconfiguration window, the reconfiguration window comprising a window within which the WTRU should perform the HO. The WTRU 102 may analyze conditions of one or more of uplink (UL) buffer status, Quality of Service (QOS) parameters, and radio conditions to determine a time within the reconfiguration window to perform the HO. The WTRU 102 may perform the HO at the determined time.

For example, the analyzing of the conditions may include analyzing current conditions.

For example, the analyzing of the conditions may include using an AI/ML model to predict future conditions.

For example, the WTRU 102 may assess the performance of the HO over multiple parameters and times. The WTRU may transmit feedback information associated with the results of the assessment to the network.

For example, the feedback information may include any of: a number of packets transmitted to a source RAN node during the reconfiguration window before HO; a number of packets transmitted to the source RAN node after the reconfiguration window starts and before the feedback information is transmitted; a number of packets re-transmitted to the source RAN node before HO; a number of packets re-transmitted to the source RAN node after the reconfiguration window starts before the feedback information is transmitted; and a UL delay budget available per a time step.

For example, the feedback information may include predictions made at the WTRU of any of uplink (UL) buffer status, Quality of Service (QOS) parameters, and/or radio conditions to determine a time within the reconfiguration window to perform the HO.

For example, the WTRU 102 may determine a configuration of a reconfiguration window (e.g., HO window) at the WTRU 102. The WTRU 102 may select to use either the reconfiguration window configuration received from the network or the reconfiguration window configuration determined at the WTRU.

### Conclusion

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.” One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, 16 or means-plus-function claim format, and any claim without the terms “means for” is not so intended.

1. A method, implemented by a wireless transmit/receive unit (WTRU), comprising:
receiving information indicating a first set of network predicted radio measurements and timestamps;
receiving configuration information indicating a handover (HO) window for a target cell and a time offset;
performing and/or predicting, by the WTRU, a second set of radio measurements based on the timestamps;
sending, at one or more first time instances that are no later than the time offset before the HO window, information indicating an evaluation of the first set of network predicted radio measurements and the second set of radio measurements, wherein the one or more first time instances are based on the HO window and the time offset; and
performing, at a second time within the HO window, a HO to the target cell based on the configuration information.

2. The method of claim 1, wherein the information indicating the HO window includes any of a start time of the HO window, an end time of the HO window, a time interval to perform the HO to the target cell, and/or the HO window is indicated as a number of milliseconds, slots, or symbols.

3. (canceled)

4. The method of claim 1, wherein the timestamps are no later than the time offset before the HO window.

5. (canceled)

6. The method of claim 1, wherein HO is a dual access protocol stack (DAPS) HO or a conditional HO.

7. The method of claim 1, wherein any of the information indicating the first set of network predicted radio measurements, and/or the configuration information indicating the HO window and/or the time offset is included in a radio resource control (RRC) message.

8. The method of claim 1, further comprising:
determining the one or more first time instances based on the HO window and the time offset; and/or
determining the second time based on a set of uplink (UL) buffer measurements satisfying a threshold.

9. (canceled)

10. The method of claim 6, further comprising:
performing and/or predicting, by the WTRU, the set of UL buffer measurements, and/or determining to perform the HO based on the configuration information and an evaluation of the first set of network predicted radio measurements and the second set of radio measurements.

11. The method of claim 6, wherein the set of UL buffer measurements are associated with one or more data radio bearers, one or more protocol data unit (PDU) sessions, and/or one or more Quality of Service flow identifiers (QFIs).

12. The method of claim 6, further comprising:
determining the set of UL buffer measurements during a time interval between a start of the HO window and the second time.

13. A wireless transmit/receive unit (WTRU), comprising:
a processor, a memory, and a transceiver configured to:
receive information indicating a first set of network predicted radio measurements and timestamps;
receive configuration information indicating a handover (HO) window for a target cell and a time offset;
perform and/or predict, by the WTRU, a second set of radio measurements based on the timestamps;
send, at one or more first time instances that are no later than the time offset before the HO window, information indicating an evaluation of the first set of network predicted radio measurements and the second set of radio measurements, wherein the one or more first time instances are based on the HO window and the time offset; and
perform, at a second time within the HO window, a HO to the target cell based on the configuration information.

14. The WTRU of claim 10, wherein the information indicating the HO window includes any of a start time of the HO window, an end time of the HO window, a time interval to perform the HO to the target cell, and/or the HO window is indicated as a number of milliseconds, slots, or symbols.

15. (canceled)

16. The WTRU of claim 10, wherein the timestamps are no later than the time offset before the HO window.

17. (canceled)

18. The WTRU of claim 10, wherein HO is a dual access protocol stack (DAPS) HO or a conditional HO.

19. The WTRU of claim 10, wherein any of the information indicating the first set of network predicted radio measurements, and/or the configuration information indicating the HO window and/or the time offset is included in a radio resource control (RRC) message.

20. The WTRU of claim 10, wherein the processor, the memory, and the transceiver are configured to:
determine the one or more first time instances based on the HO window and the time offset.

21. The WTRU of claim 10, wherein the processor, the memory, and the transceiver are configured to:
determine the second time based on a set of uplink (UL) buffer measurements satisfying a threshold.

22. The WTRU of claim 16, wherein the set of UL buffer measurements include one or more current UL buffer levels and/or one or more predicted UL buffer levels.

23. The WTRU of claim 16, wherein the set of UL buffer measurements are associated with one or more data radio bearers, one or more protocol data unit (PDU) sessions, and/or one or more Quality of Service flow identifiers (QFIs).

24. The WTRU of claim 16, wherein the processor, the memory, and the transceiver are configured to:
determine the set of UL buffer measurements during a time interval between a start of the HO window and the second time.

25. The WTRU of claim 10, wherein the processor, the memory, and the transceiver are configured to:
determine to perform the HO based on the configuration information and an evaluation of the first set of network predicted radio measurements and the second set of radio measurements.
